(19) United States
(12) Patent Application Publication
(10) Pub. No.: US 2026/0047578 A1
(43) Pub. Date: Feb. 19, 2026

(54) USE OF CLOMAZONE FOR SELECTIVE WEED CONTROL IN IMPROVED TURFGRASS

(71) Applicant: Sipcam Oxon SpA, Milano (IT)

(72) Inventor: Michael Prudhomme, Natchez, LA (US)

(21) Appl. No.: 19/294,556

(22) Filed: Aug. 8, 2025

Related U.S. Application Data
(60) Provisional application No. 63/684,066, filed on Aug. 16, 2024.

(51) Int. Cl. A01N 43/80; A01P 13/02

(52) U.S. Cl. CPC A01N 43/80; A01P 13/02

(57) ABSTRACT

The present embodiments provide methods for selectively controlling weeds in improved turfgrass, comprising applying clomazone to the improved turfgrass. Until now, clomazone has not been considered for use in improved turf due to unacceptable/anti-aesthetic bleaching properties, which are overcome by the methods described herein. The methods include consideration and management of clomazone application timing relative to turf type, turf dormancy, and overseeding timing and planting depth. The present methods provide the use of clomazone in the control of Poa (Poa annua and P. trivialis) in warm-season and cool-season improved turf types, such as Bermuda grass, Zoysia grass, St. Augustine grass, Centipede grass, Ryegrass, Fescue turf types, Kentucky Bluegrass, or mixtures of thereof. The methods further facilitate the use of clomazone to control Poa and other weeds in overseeding practices, such as overseeding with Ryegrass or Kentucky Bluegrass. These methods achieve desired turfgrass tolerance and turf aesthetics while still achieving desired selective weed control efficacy, supporting a new use for clomazone in improved turfgrass markets.

### RELATED APPLICATIONS

This application claims the priority benefit of U.S. Provisional Application No. 63/684,066, filed Aug. 16, 2024, the contents of which are incorporated fully herein by reference for all purposes.

### FIELD

The present embodiments relate to the use of clomazone for selective control of winter weeds in improved turfgrasses or turfgrass markets.

### BACKGROUND

The United States, herbicide markets are defined and strictly regulated by both Federal and State governmental agencies. Within the herbicide markets, the turf and ornamental market is a specific market segment in which both licensed applicators and Environmental Protection Agency-licensed products are regulated separately and distinctly from agriculture, aquatics, consumer, pest control, and industrial vegetation management markets. Other jurisdictions around the world have similar regulatory agencies and schemes for the regulation of herbicides in market sectors.

In the turf and ornamental markets, such as golf courses, athletic fields, residential and commercial properties, turf aesthetics (principally color, vigor, and plant health) is the primary aspect by which the quality of “improved turf” is judged from one area of turf to the next. Turf aesthetics is the single most relevant turf characteristic for which turf managers are judged and aspire to achieve. In contrast, where turf markets exist outside of turf and ornamental's improved turf markets, such as roadsides, rights-of-way, and industrial sites, turf aesthetics is either a lower priority or non-existent. Indeed, selective weed control herbicides exist and may be used for controlling weeds in areas outside of improved turf markets, but have never been introduced in turf and ornamental markets because of the herbicidal properties' adverse effects on improved turf aesthetics due to, for example, phytotoxicity, bleaching, or off-color effects, physical stunting or impaired growth rates, or root inhibition that hinders proper root system development.

Accordingly, there remains a need for methods for selective weed control in improved turfgrass for use in the turf and ornamental markets.

### SUMMARY

The embodiments described herein provide the use of clomazone-containing herbicidal formulations (e.g., pre-mixes) or preparations (e.g., spray mixes or tank mixtures) for selectively controlling weeds (broadleaf weeds, sedges, and weedy grasses such as Poa annua and Poa trivialis) in improved turfgrass while retaining acceptable turf aesthetics suitable for the improved turfgrass and ornamental markets.

At least one embodiment provides a clomazone application timing method that reduces to aesthetically acceptable levels or eliminates bleaching of improved turf types emerging from seed, such as Perennial Ryegrass, Fescue turf types, Kentucky Bluegrass, Zoysia, and Bermuda grass, while still providing post-emergent and pre-emergent weed control of target weeds such as annual bluegrass Poa annua and rough-stalk bluegrass P. trivialis (collectively “Poa”), and other winter weeds such as chickweed, dandelion, shepherds-purse, and speedwell.

An aspect of the present embodiments provides methods of using clomazone as a selective weed control product in improved turfgrass, including (1) Application timing, for example, applying about 3 days to about 7 days prior to overseeding warm-season or cool-season turf types with cool-season turf types (e.g., Ryegrass) for winter cover or increased cool-season turf density; (2) Moisture activation by rain or irrigation, generally within about 24 hours of clomazone application; (3) Clomazone use rates (e.g., use rate per application, total quantity applied if more than one application, coverage, area); (4) Fall application (time of year) for dormant, warm-season turfgrasses; and (5) Clomazone application made from about 1 week before to about the same day/time as planting seed into the soil at a depth of about 0.25 inch to about 0.5 inch (about ¼ inch to about ½ inch). Many of these methods may be used in combination to achieve desired turfgrass tolerance and turf aesthetics while still achieving desired selective weed control efficacy.

In one embodiment, the improved turfgrass in which weeds are selectively controlled by the methods of applying clomazone as described herein is Bermuda grass, Zoysia grass, St. Augustine grass, Centipede grass, Ryegrass, Fescue turf types, Kentucky Bluegrass, or mixtures of these improved turfgrasses.

In at least one embodiment, the methods described herein provide selective control of Poa in improved turfgrass, wherein applications of clomazone as described herein provide selective weed control while retaining acceptable turf aesthetics. Surprisingly, it was found that the methods described herein provide a use of clomazone that is effective in controlling Poa annua and Poa trivialis, which are known in the art as difficult, if not two of the most difficult, weeds to control in improved turfgrass.

In at least one embodiment, a method of selectively controlling Poa in improved turfgrass comprises use of a formulation comprising 3 lb. clomazone/gallon to prepare a spray mix (tank mix), or 5% clomazone granular formulation, for application at a rate of about 0.562 lb. active ingredient clomazone/acre to about 1.125 lb. active ingredient clomazone/acre, inclusive of these rates and rates therebetween. Example clomazone spray rates include 24 oz. per acre (0.562 lb. a.i./A), 32 oz. per acre (0.750 lb. a.i./acre), and 48 oz. per acre (1.125 lb. a.i./acre). In some embodiments, clomazone is applied in more than one application, for example an initial application at 32 oz. per acre, followed by a subsequent application at 16 oz. per acre within 30 to 45 days of the first application, for example in clomazone application to dormant turfgrass. Granular clomazone application rates include 11.25 lbs. per acre (0.562 lb. a.i./A), 15 lbs. per acre (0.750 lb. a.i./acre), and 22.5 lbs. per acre (1.125 lb. a.i./acre). In some embodiments, the clomazone is a microencapsulated liquid formulation. In some embodiments, the application of clomazone according to this method controls at least 80% of Poa for at least 60 days (compared with Poa control in untreated turf).

At least one embodiment provides a method of controlling pre- and post-emergent Poa in established dormant warm-season turf (e.g., Bermuda, Zoysia, St. Augustine, or Centipede grass) on, for example, a golf course, athletic field, sod farm, or residential or commercial property, by applying a spray mix comprising clomazone at a rate of about 0.562 lb. clomazone/acre to about 1.125 lb. clomazone/acre, inclusive, starting when the warm-season turfgrass is about 50% dormant to fully dormant (i.e., 100% dormant), inclusive, but at least 60 days before spring transition (green-up) is expected. Applications according to this embodiment provide selective control of existing and later-germinating Poa and other weeds. In this embodiment, restricting applications after the 60-day-before spring green-up limit (e.g., mid-January in some regions) alleviates or greatly reduces the risk of delayed spring green-up or bleaching of the warm season turf as it transitions out of dormancy.

At least one embodiment provides a method of controlling Poa and other weeds in an established Bermuda, Zoysia, St. Augustine, Centipede, Ryegrass, Fescue turf types, or Kentucky Bluegrass turfgrasses, such as turfgrass in golf courses, athletic fields, residential and commercial properties, by applying a spray mix comprising clomazone at a rate of about 0.562 lb. clomazone/acre to about 1.125 lb. clomazone/acre, inclusive, about 3 days to about 1 week prior to fall overseeding of the established Bermuda, Zoysia, St. Augustine, Centipede, Ryegrass, Fescue turf types, Kentucky Bluegrass, or mixtures of these improved turfgrasses, with Ryegrass or Kentucky Bluegrass seed, for selective control of Poa (P. annua and P. trivialis) and other winter-germinating weeds. In this embodiment, moisture activation via rainfall or irrigation is applied within about 24 hours of clomazone application. The clomazone application timing and moisture activation of the clomazone prior to germination of the cool-season turf seed results in control of existing and later germinating Poa with little to no bleaching of the germinating and emerging Ryegrass or Kentucky Bluegrass. Although application of clomazone according to this embodiment may bleach the established Bermuda, Zoysia, St. Augustine, Centipede, Ryegrass, Fescue turf types, or Kentucky Bluegrass turfgrass for about a month, the emerging green, overseeded Ryegrass or Kentucky Bluegrass minimizes negative aesthetics. Clomazone has not been labelled nor known as efficacious at controlling Poa, especially during germination and emergence of the cool-season turfgrasses, without unacceptable damage to the emerging cool-season turfgrass. Currently, no Poa-controlling herbicide is available or labelled for use during the germination and emergence periods of cool-season turfgrass due to significant seedling plant stand reductions (death) of the emerging Ryegrass or Kentucky Bluegrass turf types. Accordingly, this embodiment provides an important and surprising advantage over other Poa-controlling herbicides.

At least one embodiment provides a method of controlling Poa and other weeds during the establishment of a warm-season or cool-season sod production field (e.g., comprised of Bermuda, Zoysia, Ryegrass, Kentucky Bluegrass, or a mixture of these) by applying a spray mix comprising clomazone at a rate of about 0.562 lb. clomazone/acre to about 1.125 lb. clomazone/acre, from about 1 week before planting to the same day as planting the grass seed into the soil at a depth of about 0.25 inch. Clomazone applied in this method controls both existing Poa and future germinating/emerging Poa and other weeds without adversely affecting the germination and emergence of the recently seeded grasses (Bermuda, Zoysia, Ryegrass, Kentucky Bluegrass, or a mixture of these). Clomazone has not been labelled for nor known as efficacious at controlling Poa during germination and emergence of the planted turfgrasses without unacceptable damage to the emerging seedling turfgrasses.

At least one embodiment provides a method of controlling Poa and other weeds during the establishment of cool-season certified seed production field (e.g., comprised of Ryegrass, Fescue, or Kentucky Bluegrass) by applying a spray mix comprising clomazone at a rate of about 0.562 lb. clomazone/acre to about 1.125 lb. clomazone/acre, from about 1 week before planting up to the same day as planting the grass seed into the soil at a depth of about 0.25 to 0.5 inch. Clomazone applied in this method controls both existing Poa annua and Poa trivialis and future germinating/emerging Poa and other weeds without adversely affecting the germination and emergence of the recently seeded grasses (Ryegrass, Fescue, Kentucky Bluegrass). It should be noted that some US geographies utilize the cultural practices of planting the seed and then applying activated charcoal (also called activated carbon) over the planted seed for additional protection of the germinating seed/seedling from herbicidal effects. Although this practice is not required to safely use clomazone with the planting of Ryegrass and Kentucky Bluegrass, activated charcoal may be required for planting of Fescue in a method utilizing Clomazone as described herein. Clomazone has not been labelled for nor known as efficacious at controlling Poa annua or Poa trivialis during germination and emergence of the planted turfgrasses without unacceptable damage to the emerging seedling turfgrasses. The methods described herein support a new use of clomazone for selectively controlling weeds in improved turfgrass.

### BRIEF DESCRIPTION OF THE DRAWINGS

FIG. 1 is a photograph demonstrating control of Poa annua (Poa) in a test plot (“Clomazone Plot”) treated with clomazone according to an embodiment described herein.

FIG. 2A and FIG. 2B are photographs showing untreated (FIG. 2A) and clomazone-treated (FIG. 2B) warm-season turfgrass that was not dormant at the time of clomazone application.

FIG. 3 is a bar graph comparing the percent of Poa control in untreated with clomazone-treated dormant Bermudagrass according to an embodiment provided herein. Y axis: percent Poa control; X axis: days after treatment; black bar: untreated control (UTC); upward slash: clomazone 32 oz (Clom).

FIG. 4 is a bar graph showing the percent spring green-up (Y axis) 107 days after application of clomazone to dormant Bermudagrass according to an embodiment described herein. Dotted bar: Untreated Check (UTC); upward slash: clomazone 32 oz (Clom 32).

FIG. 5A-FIG. 5C are a series of photographs comparing spring green-up of clomazone-treated Bermudagrass when clomazone was applied at different stages of dormancy. FIG. 5A: December 5th clomazone application according to an embodiment provided herein resulted in little or no delay in spring green-up and no turf bleaching. FIG. 5B: January 26th clomazone application resulted in spring green-up delay. FIG. 5C: February 19th clomazone application resulted in significant spring-up delay and light turf bleaching.

FIG. 6A and FIG. 6B are photographs showing treatment of Bermudagrass with clomazone followed by overseeding with perennial Ryegrass according to an embodiment provided herein. FIG. 6A shows unbleached Ryegrass emerging through bleached Bermudagrass 22 days after clomazone treatment. FIG. 6B shows green Ryegrass emerging through bleached Bermudagrass 30 days after clomazone treatment in the same trial plot as shown in FIG. 6A.

FIG. 7A and FIG. 7B are photographs showing extensive bleaching of clomazone-treated Ryegrass at 29 days (FIG. 7A) and 53 days (FIG. 7B) after clomazone treatment.

FIG. 8 is a bar graph showing the control of Poa annua in Alabama test plots following fall treatments with three different concentrations of clomazone in dormant Bermuda grass according to an embodiment described herein. Y-axis percent (%) Poa control; X-axis days after treatment (DAT); dotted bar: untreated control (UTC) (0% control); horizontal lines bar: clomazone 24 oz/acre (Clom 24); upward slash (solidus) bar: clomazone at 32 oz/acre (Clom 32); black bar: clomazone 48 oz/acre (Clom 48); white bar: mixture of Sim-Trol® (simazine)/Specticle® (indaziflam) comparator (SimTrol+Spec).

FIGS. 9A and 9B are bar graphs showing the control of Poa annua in Virginia test plots following fall or winter treatments with three different concentrations of clomazone, versus comparators, in dormant Zoysia grass according to an embodiment described herein. FIG. 9A: Treatments applied in November; Y-axis: % Poa control; X-axis: DAT; dotted bar: untreated control (UTC) (0% control); horizontal lined bar: clomazone 24 oz/acre (Clom 24); solidus bar: clomazone at 32 oz/acre (Clom 32); black bar: clomazone 48 oz/acre (Clom 48); white bar: mixture of Sim-Trol®/Specticle® (SimTrol+Spec). FIG. 9B: Treatments applied in January, Y-axis % Poa control; X-axis DAT; dotted bar: untreated control (UTC) (0% control); horizontal lined bar: clomazone 24 oz/acre (Clom 24); solidus bar: clomazone at 32 oz/acre (Clom 32); solid black bar: clomazone 48 oz/acre (Clom 48); white bar: flumioxazin (Flum).

FIGS. 10A and 10B are bar graphs showing Poa annua coverage in South Carolina test plots following winter treatments with three different concentrations of clomazone, versus comparators, in dormant Bermuda grass according to an embodiment described herein. FIG. 10A: Treatments applied in December; Y-axis: % Poa coverage; X-axis: DAT; dotted bar: untreated control (UTC) (significant coverage all DAT); horizontal lined bar: clomazone 24 oz/acre (Clom 24); solidus bar: clomazone at 32 oz/acre (Clom 32); black bar: clomazone 48 oz/acre (Clom 48); white bar: Sim-Trol®/Specticle® (SimTrol+Spec). FIG. 10B: Treatments applied in January, Y-axis % Poa coverage; X-axis DAT; dotted bar: untreated control (UTC) (0% control); horizontal lined bar: clomazone 24 oz/acre (Clom 24); solidus bar: clomazone at 32 oz/acre (Clom 32); solid black bar: clomazone 48 oz/acre (Clom 48); white bar: flumioxazin (Flum).

FIG. 11 is a bar graph showing the control of Poa annua in Tennessee test plots following winter (January) treatments with three different concentrations of clomazone, or a mixture of clomazone and glyphosate, versus comparators, in dormant Bermuda grass according to an embodiment described herein. Y-axis % Poa control; X-axis DAT; dotted bar: untreated control (UTC) (0% control); horizontal lined bar: clomazone 24 oz/acre (Clom 24); solidus bar: clomazone at 32 oz/acre (Clom 32); black bar: clomazone 48 oz/acre (Clom 48); white bar: glyphosate (Glyph); light reverse solidus bar: glyphosate/flumioxazin (Glyph+Flum); heavy reverse solidus bar: 32 oz/acre clomazone/32 oz/acre glyphosate (Clom+Glyph).

FIG. 12 is a bar graph showing control of Poa annua in dormant Bermuda grass Tennessee test plots following winter (January) treatments with three different concentrations of clomazone, or sequential first and second treatments with clomazone embodiments as described herein, versus a comparator. Y-axis % Poa control; X-axis DAT; dotted bar: untreated control (UTC) (0% control); light horizontal lined bar: clomazone 24 oz/acre (Clom 24); solidus bar: clomazone at 32 oz/acre (Clom 32); black bar: clomazone 48 oz/acre (Clom 48); white bar: Sim-Trol®/Specticle® (SimTrol+Spec); heavy horizontal lined bar: clomazone 24 oz/acre followed by clomazone 17 oz/acre (Clom24+Clom17); reverse solidus bar: clomazone 32 oz/acre followed by clomazone 17 oz/acre (Clom32+Clom17).

FIG. 13 is a bar graph showing the percent Poa trivialis control in Tennessee test plots following treatment with clomazone according to an embodiment described herein, compared with several herbicides. Y-axis % Poa control; X-axis DAT; dotted bar: untreated control (UTC) (0% control); white bar: bispyribac sodium at 2.25 oz/acre (Bisp); light solidus bar: paclobutrazol PGR at 48 oz/acre (Pacl); reverse solidus: methiolzolin at 51 oz/acre (Meth); horizontal lined bar: amicarbazone at 4 oz/acre (Amic); heavy solidus bar: clomazone at 32 oz/acre (Clom 32).

FIG. 14 is a bar graph showing spring green-up of Bermuda that had been treated with clomazone as described herein, or comparators in fall (November, date A) or winter (January, dateB) in Alabama test plots. Y-axis: % green-up; X-axis: DAT after A treatment; dotted bar: untreated control (UTC); light horizontal lined bar: fall clomazone 24 oz/acre (Clom 24A); thin solidus bar: fall clomazone at 32 oz/acre (Clom 32A); white-on-black dotted bar: fall clomazone 48 oz/acre (Clom 48A); white bar: fall Sim-Trol®/Specticle® (SimTrol+Spec); heavy horizontal lined bar: winter clomazone 24 oz/acre (Clom 24B); heavy solidus bar: winter clomazone at 32 oz/acre (Clom 32B); solid black bar: winter clomazone 48 oz/acre (Clom 48B); vertical stripes bar: winter flumioxazin (Flum).

FIG. 15 is a bar graph comparing spring green-up in South Carolina test plots following treatment of dormant Bermuda with three concentrations of clomazone in December (A date) or January (B date), in example embodiments described herein, or a comparator, then assessed for green-up in April, 115 DAT from the December application. Y-axis: % green-up; X-axis: treatments; dotted bar: untreated control (UTC); light horizontal lined bar: trial A clomazone 24 oz/acre (Clom 24A); thin solidus bar: trial A clomazone 32 oz/acre (Clom 32A); white-on-black dotted bar: trial A clomazone 48 oz/acre (Clom 48A); heavy horizontal lined bar: trial B clomazone 24 oz/acre (Clom 24B); heavy solidus bar: trial B clomazone at 32 oz/acre (Clom 32B); black bar: winter clomazone 48 oz/acre (Clom 48B); vertical stripes bar: trial B flumioxazin (Flum).

FIG. 16A and FIG. 16B are bar graphs showing green-up (FIG. 16A) and phytotoxicity/bleaching (FIG. 16B) in Tennessee test plots treated in December with three concentrations of clomazone (A date), or treated with a first (December) (A date) then second (January) (B date) application of clomazone, or treated in January (B date) with three concentrations of clomazone or with a mixture of clomazone and glyphosate, then assessed for percent green-up and percent phytotoxicity/bleaching in March and April, 97 DAT and 112 DAT from the December application date (DAT-A), respectively, in embodiments of the present methods. FIG. 16A: Y-axis % green-up; X-axis DAT-A; dotted bar: untreated control (UTC); horizontal lined bar: clomazone 24 oz/acre (Clom 24A); light solidus bar: clomazone 32 oz/acre (Clom 32A); white-on-black dots bar: clomazone 48 oz/acre (Clom 48A); horizontal broken line bar: 1st clomazone 24 oz/acre then 2nd clomazone 17 oz/acre (Clom 24+17); vertical broken line bar 1st clomazone 32 oz/acre then 2nd clomazone 17 oz/acre (Clom 32+17); heavy horizontal lined bar: clomazone 24 oz/acre (Clom 32B); heavy solidus bar: clomazone 32 oz/acre (Clom 32B); black bar: clomazone 48 oz/acre (Clom 48B); heavy reverse solidus bar: 32 oz/acre clomazone/32 oz/acre glyphosate (Clom+Glyph). FIG. 16B: Y-axis % phytotoxicity/bleaching; X-axis bar: same as FIG. 16B.

FIG. 17 is a bar graph showing the assessment of spring health in Mississippi Bermuda grass test plots treated in December with either one of three clomazone concentrations according to embodiments described herein, or a mixture of 32 oz/acre Sim-Trol, 6 oz/acre Specticle and 1 oz/acre Tribute® Total (thiencarbazone-methyl, foramsulfuron, halosulfuron-methyl) (A date); or treated in January (B date) with either one of three clomazone concentrations according to embodiments described herein, or flumioxazin. Test plots were assessed for turf injury in March (100 DAT-A), early April (113 DAT-A) and late April (140 DAT-A). Y-axis: % turf injury; X axis DAT-A; dotted bar: untreated control (UTC) (0% injury); light horizontal lined bar: clomazone 24 oz/acre (Clom 24A); light solidus bar: clomazone at 32 oz/acre (Clom 32A); white-on-black dots bar: clomazone 48 oz/acre (Clom 48A); white bar: Sim-Trol®/Specticle®/Tribute® (SimTrol+Spec+Trib); heavy horizontal lined bar: clomazone 24 oz/acre (Clom 24B); heavy solidus bar: clomazone at 32 oz/acre (Clom 32B); solid black bar: clomazone 48 oz/acre (Clom 48B); vertical lines bar: flumioxazin (Flum).

FIG. 18 is a bar graph showing turf health as a function of phytotoxicity/bleaching in Virginia Zoysia grass test plots as described in FIG. 9A (date A) and FIG. 9B (date B), then percent phytotoxicity/bleaching assessed in April (group 1 data) and May (group 2 data), and percent plot turf coverage in May (group 3 data). Y-axis: % phytotoxicity/bleaching or % turf coverage; X-axis: DAT-A; dotted bar: untreated control (UTC) (0% phytotoxicity/bleaching); light horizontal lined bar: clomazone 24 oz/acre (Clom 24A); light solidus bar: clomazone 32 oz/acre (Clom 32A); white-on-black dotted bar: clomazone 48 oz/acre (Clom 48A); white bar: Sim-Trol®/Specticle® (SimTrol+Spec); heavy horizontal lined bar: clomazone 24 oz/acre (Clom 24B); heavy solidus bar: clomazone 32 oz/acre (Clom 32B); black bar: clomazone 48 oz/acre (Clom 48)B; vertical lined bar: flumioxazin (Flum).

FIG. 19A-FIG. 19C are bar graphs showing results of experiments in Alabama test plots using clomazone, or a comparator, in novel clomazone uses for controlling Poa in Ryegrass overseeding of dormant Bermuda grass in embodiments as described herein. FIG. 19A shows assessment of Poa control 182 DAT, Y-axis % Poa control; dotted bar: untreated control (UTC); horizontal lined bar: clomazone 24 oz/acre (Clom 24); tight solidus bar: clomazone 32 oz/acre; white-on-black dots bar: clomazone 48 oz/acre (Clom 48); white bar: comparator (Revolver). FIG. 19B shows percent of turf injury/bleaching of Bermuda grass at 7 DAT, 15 DAT, 29 DAT, or 42 DAT, and percent of injury/bleaching of the overseeded emerged Ryegrass 29 days after planting (29 DA), Y-axis % turf injury/bleaching; X-axis DAT or DA (29 DA Rye); dotted bar: untreated control (UTC); horizontal lined bar: clomazone 24 oz/acre (Clom 24); solidus bar: clomazone 32 oz/acre; black bar: clomazone 48 oz/acre (Clom 48); white bar: comparator (Revolver). FIG. 19C shows the percent coverage of overseeded Ryegrass at four dates after seeding, Y-axis % Rye coverage; X-axis days after planting; bars as in FIG. 19B.

FIG. 20A and FIG. 20B are bar graphs showing Poa control (FIG. 20A) and Bermuda turf injury (FIG. 20B) in North Carolina test plots using clomazone in embodiments as described herein, or a comparator, for controlling Poa in Ryegrass overseeding of dormant Bermuda grass. FIG. 20A, Y-axis % Poa control; X-axis DAT; bars as in FIG. 19B. FIG. 20B, Y-axis % Bermuda injury/bleaching; X-axis DAT and end of study (Duration); bars as in FIG. 19B.

FIG. 21A and FIG. 21B are bar graphs showing Poa control (FIG. 21A) and Ryegrass coverage in Tennessee test plots using clomazone in embodiments as described herein, or a comparator, for controlling Poa in Rye overseeding of dormant Bermuda grass. FIG. 21A, Y-axis % Poa control; X-axis DAT; bars as in FIG. 19B. FIG. 21B, Y-axis % Ryegrass turf coverage; X-axis days after overseeding; bars as in FIG. 19B.

FIG. 22A-FIG. 22D are bar graphs showing Ryegrass bleaching (FIG. 22A), Bermuda grass bleaching (FIG. 22B), Bermuda grass turf injury (FIG. 22C), and Ryegrass coverage (FIG. 22D) in Virginia test plots using clomazone treatments in embodiments as described herein, or a comparator, for controlling Poa in the Ryegrass overseeding of dormant Bermuda grass. FIG. 22A Y-axis % bleached Ryegrass; X-axis DAT; bars as in FIG. 19B. FIG. 22B Y-axis % bleached Bermudagrass; X-axis DAT; bars as in FIG. 19B. FIG. 22C Y-axis % Bermuda turf injury; X-axis DAT; bars as in FIG. 19B. FIG. 22D Y-axis % plot coverage by Ryegrass; X-axis DAT; bars as in FIG. 19B.

### DETAILED DESCRIPTION

It should be understood that this invention is not limited to the particular methodology, protocols, and reagents, etc., described herein and as such may vary. The terminology used herein is for the purpose of describing particular embodiments only, and is not intended to limit the scope of the present invention, which is defined solely by the claims.

All patents and other publications identified are incorporated herein by reference for the purpose of describing and disclosing, for example, the methodologies described in such publications that might be used in connection with the present invention, but are not to provide definitions of terms inconsistent with those presented herein. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on information available to the applicants and do not constitute any admission as to the correctness of the dates or contents of these documents.

As used herein and in the claims, the singular forms “a,” “an,” and “the” include the plural reference unless the context clearly indicates otherwise. Throughout this specification, unless otherwise indicated, “comprise,” “comprises” and “comprising” are used inclusively rather than exclusively, so that a stated integer or group of integers may include one or more other non-stated integers or groups of integers. The term “or” is inclusive unless modified, for example, by “either.” Thus, unless context indicates otherwise, the word “or” means any one member of a particular list and also includes any combination of members of that list. As used herein, all numerical values relating to amounts, percentages, and the like, are defined as “about” or “approximately” each particular value, namely, plus or minus 10% (±10%), unless context clarifies otherwise or those skilled in the art understand practical limitations to the recitation. For example, the phrase “about 5%” is to be understood as “4.5% to 5.5%, inclusive of these and amounts therebetween.”

Clomazone (IUPAC 2-[(2-Chlorophenyl)methyl]-4,4-dimethyl-1,2-oxazolidin-3-one; CAS No. 81777-89-1) is a Group 13, isoxazolidinone herbicide compound that suppresses chlorophyl biosynthesis, represented by the formula:

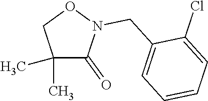 [SMILES: CC1(C)CON(Cc2ccccc2Cl)C1=O]

Clomazone was first registered by the U.S. EPA in the 1980's for control of broadleaf weeds in a variety of agricultural crops. Clomazone is available commercially, for example, as Caravel® Herbicide (Sipcam Agro USA, Inc.), formulated as either liquid containing 3.0 lbs of clomazone per gallon, or a granular formulation containing a 5% clomazone impregnated on granules. In the years since clomazone was launched as a pre-emergent herbicide for use in agricultural crops, however, clomazone has not been evaluated for potential use in the Improved Turf markets due to its anti-aesthetic characteristics of bleaching both non-target desirable plants and target weeds for 4 to 6 weeks. Additionally, clomazone has not been evaluated for control of fall or winter germinating weeds (no winter weeds exist on the weed list clomazone claims to control), including Poa annua, P. trivialis (collectively “Poa”), chickweed, dandelion, shepherds-purse, and speedwell. In some instances, clomazone may be applied to control an undesired presence of Bentgrass.

The present embodiments provide methods for the use of clomazone in improved turf markets, in which weeds such as Poa are controlled while retaining acceptable turf aesthetics. These embodiments reflect extensive development efforts that surprisingly provide refined application methods that allow clomazone to be used for selective weed control in improved turf markets and turf types without effecting turfgrass aesthetics to unacceptable levels.

As used herein, “selective control” means that the target weed is killed or inhibited while the surrounding improved turfgrass is not killed, damaged (e.g., bleached), or inhibited to the extent it would substantially impact the aesthetic appearance of the turfgrass or turfgrasses for a great length of time. Control may be expresses as a percent suppression of the target weed(s). Selective control may include initial damage to turfgrass, which then quickly rebounds from clomazone applied as described herein, such that aesthetic appeal is not adversely impacted for a great length of time.

A phytotoxicity rating scale may be used to rate whether a selective herbicide's negative effects on an improved turf is acceptable. For example, a phytotoxicity rating uses a scale of 0 (lowest) to 100 (highest) percent scale relative to a non-treated control plot. More specifically, turf injury ratings may be based on 0 to 100 where 0 equals no injury or shoot discoloration and 100 equals complete kill. On this scale, 1% to 25% represents slight but acceptable injury, 26% to 40% generally represents unacceptable injury unless it lasts for less than a week, and 41% and higher represents severe and unacceptable injury regardless of how long it lasts. Generally, a phytotoxicity rating of 25% or more (i.e., higher) is unacceptable in a commercial setting where turf aesthetics are valued. A rating of less than 25% phytotoxicity that diminishes to zero over time—typically in about 2 weeks (about 14 days)—is generally considered acceptable. In some circumstances (e.g., depending on the weed infestation and planned use of a turf), 3 weeks (about 21 days) may be an acceptable time frame for turf recovery after clomazone treatment as described herein. Conversely, a phytotoxicity rating from 41% to 90% phytotoxicity indicates significant turf damage and is generally unacceptable in applications where turf aesthetics should be retained.

Turf toxicity ratings are made at a suitable time or over time as appropriate for the application, area use, and type of turf: it should be noted that acceptable versus unacceptable phytotoxicity may vary based on area use and customer expectation. For example, in the context of golf courses, a 10% injury might be acceptable for a fairway or rough, but unacceptable for a putting green. Additionally, for example, 40% phytotoxicity may be commercially acceptable if it lasts only short time (e.g., less than a week) before quickly retreating below the 25% threshold, and the phytotoxicity or visible turf impairment is over in a matter of a few days as opposed to lasting a longer time (e.g., about 2 weeks).

Additionally, turf quality ratings may also be based on 0 to 100, where 0 equals completely brown or dead turf and 100 equals dark green uniform dense turf. Turf growth ratings may also be based on percent ground cover where 0 equals no grass and 100 equals completely uniform cover. Such turf phytotoxicity ratings are widely accepted as discussed, for example, in Johnson, Turfgrass Species Response to Herbicides Applied Postemergence, 1(4) Weed Technol. 305-211 (1987). At least one embodiment provides the use of clomazone for the control of weeds at a 25% or better (i.e., lower) phytotoxicity rating. Additionally, one skilled in the art may frequently distinguish phytotoxicity ratings (physical stunting, necrosis or other detrimental effects to normal growth) separate from turf bleaching ratings which are purely aesthetic in nature with no detrimental turf growth impairment characteristics.

It should be noted, however, that particularly when phytotoxicity is short lived or an infestation demands emergency control, dyes or pigment additions to spray mixes may temporarily mask the phytotoxicity if clomazone is applied directly to actively growing turf, when the phytotoxicity is otherwise visually/aesthetically unacceptable but mostly superficial and short lived (i.e., tolerable).

As used herein, “herbicide” and “herbicidal active ingredient” refers to an active ingredient (a.i.) that kills, controls, or otherwise adversely modifies the growth and development of vegetation, particularly undesirable vegetation, such as weeds, volunteer crops, and other plant species that differ from the plant species intended for growth, when applied in an appropriate amount or under appropriate conditions.

As used herein, control of or controlling undesirable vegetation means killing, suppressing, or preventing the vegetation, or causing some other adverse modifying effect to the vegetation e.g., deviations from natural growth or development, regulation, phytotoxicity, desiccation, retardation, and the like.

As used herein, a “herbicidally effective amount” refers to an amount of an herbicidal active ingredient that causes a “herbicidal effect,” i.e., controlling undesirable vegetation. The term “effective amount” means the amount of an herbicide, herbicidal formulation, or herbicidal mixture (e.g., tank mix) that controls a weed (i.e., provide an adversely modify effect). The “effective amount” will vary depending on the herbicide concentration, the type of turfgrasses being treated, environmental conditions, the severity of the weed infestation, the result desired, the weed size, and the life stage of the weeds during treatment, among other factors. Thus, it is not always possible to specify an exact “effective amount.” An appropriate “effective amount” in any individual case may be determined by one of ordinary skill in the art in light of this specification. Efficacy may be expressed on a scale of 0% to 100%, with 100% indicating death of 100% the target weed in the treated area. Commercially and among the weed science community, acceptable efficacy (weed control) is uniformly considered 80% control of the target weed.

As used herein, “applying an herbicide” means delivering it directly to the targeted undesirable vegetation or to the locus thereof, or to the area where control of undesired vegetation is desired. Methods of application include, but are not limited to preemergence and postemergence applications. Described herein are methods of controlling undesirable vegetation by applying clomazone and certain clomazone compositions or formulations at particular rates or particular timings (e.g., depending on turfgrass type, stage of dormancy, or planned overseeding).

Clomazone should not be applied in excess of the maximum rate approved by regulatory authorities, and all product label instructions and safety information should be followed.

As used herein, plants and vegetation include, for instance, dormant seeds, germinating seeds, emerging seedlings, plants emerging from vegetative propagules, immature vegetation, and established vegetation.

Application of clomazone as described herein may be done before, during, or after the emergence of the undesirable vegetation, depending on considerations (e.g., turf type, turf type dormancy, weed type, weed size, active ingredient application rate, spray mix) as described herein.

As used herein, the terms “undesirable vegetation”, “undesirable species”, “undesirable plants”, “harmful plants”, “undesirable weeds”, “weeds” or “harmful weeds” are synonyms. It should be noted that the term weed may depend on the context or setting of the turfgrass. For example, Bentgrass may be a desired turfgrass in some areas of a golf course, but undesired in other areas of a golf course.

Turfgrasses can form a continuous ground cover that persists under regular mowing and traffic. Improved turfgrass varieties have been bred for increased density, better color, deeper rooting, and improved disease resistance. Improved turfgrass may also require less watering, through both deeper rooting and reduced stomata (leaf pores), require less fertilizer while maintaining good color, require less mowing, and have slower rates of growth. Many turfgrasses are grown for their aesthetic appeal, moderate maintenance, and moderate to high quality.

The present embodiments may be practiced on a variety of warm- and cool-season turfgrasses. Sports turfgrasses function as athletic or recreation play surfaces, generally receive high maintenance, are of high quality, and able to endure heavy foot traffic. For example, improved Kentucky bluegrasses (Poa pratensis), perennial Ryegrasses (e.g., Lolium perenne L.), turf-type tall fescues (Festuca arundinacea cultivars), Bermuda grasses (Cynodon species such as C. dactylon), Centipede grass (Eremochloa ophiuroides), St. Augustine grass (Stenotaphrum secundatum), and Zoysia grasses (Zoysia species) are used as sports turfgrasses in various parts of the U.S. These grasses are often grown on golf course greens, tees, fairways and roughs, baseball fields, football fields, soccer pitches, and other sports/athletic sites. Many turf managers employ mixtures of turfgrasses to provide the turfgrass coverage suitable for the particular site. Additionally, warm-season turfgrasses that go dormant (and turn brown) in the winter are often overseeded in the fall with cool-season turfgrasses to provide useful (e.g., some protection to the dormant turf from high levels of foot or equipment traffic and extreme cold) and aesthetically pleasing turfs throughout the winter months. Lawn turfgrasses are commonly planted on residential or home lawns, commercial areas, park settings, and other landscape areas requiring turf having a good appearance. Accordingly, the present embodiments may be practiced with warm-season or cool-season improved turfgrasses including their varieties and hybrids and mixtures of these.

In at least some embodiments, improved turfgrass in which weeds are selectively controlled by the methods of applying clomazone as described herein include Bermuda grass, Centipede grass, Zoysia grass, St. Augustine grass, Fescue turf types, Kentucky Bluegrass, or mixtures of these improved turfgrasses.

Improved turfgrass installations envisioned for application of the embodiments described herein include golf courses, athletic fields, residential and commercial properties, commercial turf seed (certified seed), or sod production facilities. Ideally, these installations have access to irrigation to provide activation of clomazone according to embodiments described herein.

Additionally, the methods described herein provide selective control of Poa, which is particularly advantageous for retaining turf aesthetics in improved turfgrasses such as Bermuda grass, Zoysia grass, St. Augustine grass, Ryegrass, Kentucky Bluegrass, and Fescue grasses.

The methods described herein further provide selective control of Poa and other weeds in cool-season turfgrass, such as Ryegrass, often used to overseed warm-season turfs. According to this method as detailed herein, the timing of clomazone application, moisture application, and overseeding provide selective weed control concurrent with acceptable turf aesthetics.

At least one embodiment provides for a method of selective weed control in improved turfgrass comprising preparing a spray mix (tank mix) of 3 lb. clomazone/gallon for an application at a rate of about 0.562 lb. clomazone/acre to about 1.125 lb. clomazone/acre, inclusive of these rates and rates therebetween. In some embodiments, the clomazone is an encapsulated liquid formulation. For example, methods for production of microencapsulated clomazone formulations are described in U.S. Pat. No. 9,764,302. At least one embodiment provides for a method of selective weed control in improved turfgrass comprising application of a granular preparation of 5% clomazone at a rate of about 0.562 lb. clomazone/acre to about 1.125 lb. clomazone/acre, inclusive of these rates and rates therebetween.

It should be noted that in at least some embodiments, clomazone applications require moisture for “activation.” In general, activation of clomazone can be achieved with rain or irrigations of at least 0.25 inches of water or at least 0.5 inches of water, e.g., if the soils contain some moisture and are not completely dry, or 1.0 inch of water if the soils are completely dry. In some embodiments, water should be received (rain) or applied (irrigation) within about 24 hours following application of the clomazone-containing preparation.

Weeds that have been noted as controlled by clomazone for use in U.S. jurisdictions licensed agricultural application include broadleaves such as balloonvine, nightshade, plaintain, cocklebur, ragweed, dock, dayflower, beggarweed, galinsoga, jimsonween, joint vetch, kochia, lambsquarter, pigweed, pitted morning glory, prickly sida, prostrate spurge, purslane, redvine, redweed, smart weed (Persicaria maculosa and Polygonum pensylvanicm), spurred anoda, tropic croton, velvetleaf, venice mallow, and wild poinsettia, and grasses such as barnyardgrass, bermudagrass, broadleaf signalgrass, crabgrass, cupgrass, field sandbur, foxtail, goosegrass, itchgrass, junglerice, panicum, red rice, seedling johnsongrass, shattercane, and wild proso millet. Of note for these agricultural applications, bermudagrass is included in the list of weeds controlled by application of clomazone, but the present embodiments provide methods whereby clomazone may be used to control weeds in bermudagrass. Also of note for these agricultural applications, although some annual grasses may be suppressed by application of clomazone, Poa (P. annua, P. trivialis) is not included in grasses listed as susceptible to clomazone, nor are chickweed, dandelion, shepherds-purse and speedwell listed as broadleaf weeds susceptible to clomazone.

In one aspect of the present embodiment, a clomazone-containing formulation can be in the form of emulsifiable concentrates (EC), micro-emulsions (ME), suspension concentrates (SC), oil-based suspension concentrates (OD), flowable suspensions (FS), water-dispersible granules (WG), wettable powders (WP), water soluble powders (SP), aqueous suspo-emulsions (SE), capsule suspensions (CS), dry flowable (DF), water-soluble concentrate (SL), granules (GR), impregnated granules (CG), fine granules (FG), microgranules (MG), fertilizer granules, or a combination of these. In one embodiment, the clomazone formulation is a liquid comprising microencapsulated clomazone formulation. In one embodiment, the clomazone formulation is a granular formulation. The appropriate method of application of a formulation may factor-in the month or temperature for the particular formulation, and may also factor-in whether an adjuvant is present in the formulation or tank mix, as described herein.

Clomazone formulations (premixes) of the present embodiments may include, besides the active ingredient(s), at least one agronomically acceptable excipient. Exemplary agronomically acceptable excipients may include but are not limited to, adjuvants, antifreeze agents, antifoam agents, compatibility agents, sequestering agents, anti-caking agents, neutralizing agents and buffers, corrosion inhibitors, colorants, odorants, penetration aids, wetting agents, spreading agents, dispersing agents, thickening agents, freeze point depressants, antimicrobial agents, crop oil, safeners, surfactants, protective colloids, emulsifiers, tackifiers, and mixtures thereof. Such agronomically acceptable excipients are known in the art and are commercially available. Their use in the formulation of the compositions of the present embodiment will be apparent to the person skilled in the art in light of the present disclosure. For example, some adjuvants may not be appropriate for clomazone-containing foliar sprays or on certain turf types.

The clomazone formulations may include one or more surfactants which are preferably non-ionic, cationic or anionic in nature and surfactant mixtures which have good emulsifying, dispersing and wetting properties, depending upon the active compound/compounds being formulated. Suitable surfactants are known in the art and are commercially available.

Further exemplary agronomically acceptable premix excipients may include one flow agent or anti-caking agent (e.g., Hisil® 233), emulsifier (e.g., Ethox P-104), anti-freeze agent (e.g., polyethylene glycol), anti-foaming agent (e.g., anti-foam FG-10), dispersant (e.g., Tersperse® 2020), biocide (e.g., Proxel® GXL), or thickener (e.g., Kelzan®).

Clomazone premix formulations of the present embodiments may be formulated as suspension concentrates and derivatives thereof. The active ingredients may be incorporated into a suspension concentrate. The term “suspension concentrate” as used herein, means a composition also sometimes referred to as an “aqueous flowable” or a “water-based flowable” composition, which compositions are known in the herbicide art and include or consist of particles of a generally insoluble solid active herbicide compound in suspension (preferably concentrated suspension) in water. The suspension concentrates described herein can be produced with particles of the active ingredients by suspending and preferably dispersing the particles in water with the assistance of other ingredients such as conventional dispersants, surfactants (wetting agents), and other optional ingredients. The active ingredients should be in the form of particles that exhibit physical characteristics such as size, shape, surface features, etc., that will allow the active ingredient particles to be suspended in water as described. The particle size range can vary depending on factors such as the other ingredients used to prepare the suspension concentrate and their respective amounts, but exemplary particles may be in the size range below about 10 microns, for example in the range from about 4 or 5 microns to about 7 or 8 microns, inclusive.

The suspension concentrate typically includes water in a useful amount, such as an amount that, in combination with one or more other ingredients described herein (e.g., such as surfactant or dispersant) will allow suspension and preferably dispersion of the active ingredient particles. Relative amounts of water and the other ingredients used to prepare a suspension concentrate can be any amounts that produce a useful herbicide formulation in the form of a suspension concentrate. Relative amounts of different ingredients (water, active ingredients, surfactant, etc.) in any particular composition can depend on the intended application (including the plant to be controlled or the crop to be protected), the mode of application (e.g., field or aerial spraying or application from a hand-held spray applicator, or other technique), the method of any preparation from a suspension concentrate to a herbicide application composition, the amounts and identities of other ingredients added to the suspension concentrate, etc. Useful amounts of water in a suspension concentrate may be, for example, in the range from about 20 to about 60 wt % water based on the total weight of the suspension concentrate, such as from about 30 to about 50 wt % water in a suspension concentrate.

Wettable powders (sprayable powders) are products that are uniformly dispersible in water and that, in addition to the active ingredients and one or more diluents or inert substances, also comprise ionic or nonionic surfactants (wetting agents, dispersants), for example alkanesulfonates or alkylbenzenesulfonates or alkylnaphthalenesulfonates, sodium lignosulfonate, sodium 2,2′-dinaphthylmethane-6,6′-disulfonate, sodium dibutyl-naphthalenesulfonate or else sodium oleoylmethyltauride.

Emulsifiable concentrates may be prepared by dissolving the active ingredients in an organic solvent or solvent mixture, for example butanol, cyclohexanone, dimethylformamide, acetophenone, xylene or else higher-boiling aromatics or hydrocarbons with addition of one or more ionic or nonionic surfactants (emulsifiers). Examples of emulsifiers which may be used are: calcium alkylarylsulfonates such as calcium dodecylbenzenesulfonate, or nonionic emulsifiers such as fatty acid polyglycol esters, alkylaryl polyglycol ethers, fatty alcohol polyglycol ethers, propylene oxide-ethylene oxide copolymers, alkyl polyethers, sorbitan fatty acid esters, polyoxyethylene sorbitan fatty acid esters or polyoxyethylene sorbitol esters.

Oil dispersions are oil-based suspensions of active ingredients, where oil is to be understood as meaning any organic liquid, for example vegetable oils, aromatic or aliphatic solvents, or fatty acid alkyl esters. They can be prepared, for example, by wet grinding by means of commercially available bead mills and, if appropriate, addition of further surfactants (wetting agents, dispersants) as have already been mentioned, for example, above in the case of the other formulation types. In addition to the suspended active compound or active compounds, other active compounds may also be present in the formulation in dissolved form.

Granules can be prepared either by spraying the active ingredients onto adsorptive, granulated inert material or by applying active compound concentrates to the surface of carriers such as sand, kaolinites, chalk or granulated inert material with the aid of binders, for example polyvinyl alcohol, sodium polyacrylate, or mineral oils. Suitable active ingredients can also be granulated in the manner customary for the preparation of fertilizer granules if desired as a mixture with fertilizers. Water-dispersible granules are produced generally by customary processes such as spray-drying, fluidized bed granulation, pan granulation, mixing with high-speed mixers and extrusion without solid inert material. The production of pan granules, fluidized bed granules, extruder granules, and spray granules are also known in the art. See, e.g., PROCESSES IN SPRAY-DRYING HANDBOOK (3rd ed., G. Goodwin Ltd., London, 1979); Browning, AGGLOMERATION, IN CHEMICAL & ENGINEERING, pages 147 (1967); PERRY'S CHEMICAL ENGINEER'S HANDBOOK, at 8-57 (5th ed., McGraw-Hill, New York 1973).

Details and protocols regarding the formulation of many herbicidal compositions are known in the art. See, e.g., Klingman, WEED CONTROL AS A SCIENCE, at 81-96 (John Wiley & Sons, Inc., New York, 1961); Freyer & Evans, WEED CONTROL HANDBOOK, at 101-03 (5th ed., Blackwell Sci. Publ., Oxford, 1968).

It should be noted that the discussion of formulations pertaining to premixes may be distinguished from preparations of spray mixes (tank mixes) prepared using formulations or premixes, water and, optionally, agriculturally acceptable excipients, to prepare a mixture (tank mix or spray mix) for application (e.g., spray) to the improved turfgrass. In this context, an exemplary agriculturally acceptable excipient often added to a spray mix may be an adjuvant. Addition of an adjuvant to a spray mix may optimize the performance of the herbicide formulation and reduce the number of products that the end user has to add to the spray mix. Example adjuvants are non-ionic surfactants (NIS), e.g., at a concentration of about 0.25% v/v; a crop oil concentrate (e.g., mineral oil), e.g., at a concentration of about 1% v/v; or a methylated seed oil (MSO), e.g., at a concentration of about 0.6% v/v. Such adjuvants are not generally appropriate, however, for all clomazone-containing foliar spray mixes or on certain turf types. Indeed, in at least one embodiment spray mix/tank-mix adjuvants are excluded from clomazone-containing applications to provide selective weed control with while minimizing damage to improved turfgrass (i.e., minimizing phytotoxicity to an acceptable level or retaining an acceptable level of turf aesthetics, e.g., below 25%).

In some embodiments, such as when clomazone is applied to dormant turfgrasses, clomazone may be combined with at least one additional herbicide as either a formulation (e.g., premix) or in a spray mix (tank mix) for selective control of weeds while retaining acceptable turf aesthetics (e.g., a phytotoxicity rating of 25% or less). For example, clomazone may be combined with glyphosate, glufosinate, prodiamine, atrazine, simazine, oxadiazon, flumioxazin, indaziflam, or other herbicides or pesticides.

In some embodiments, such as when clomazone is applied before or during seeding, overseeding, sprigging, or laying sod, clomazone is not combined with another herbicide or pesticide.

In an aspect of the present embodiments, clomazone is surprisingly effective for selective control of pre- and post-emergent growth of two particularly noxious invasive weeds, Poa annua L. (annual bluegrass) and Poa trivialis (roughstalk bluegrass), while retaining acceptable turf aesthetics. Annual bluegrass is one of the most common weeds of residential and commercial turfgrass, ornamental plantings, and gardens. Roughstalk bluegrass is a cool-season perennial grass that may often infect residential and commercial turfgrass, ornamental plantings, and gardens, turning an unsightly brown when summer temperatures arrive in the South. Collectively referred to as “Poa” herein, these are problematic in sports fields, golf course greens and fairways. In turfs, Poa forms a weak sod that provides poor footing for athletic fields and golf courses. In putting greens, unsightly seed heads of Poa reduce the aesthetic turf quality and disrupt the smooth rolling surface. Because it is a grass weed growing in turfgrass, selectively removing Poa is accepted as challenging. Once a few Poa plants become established in turf or ornamental areas, spread can be rapid because of its prolific and rapid seed production: mowing, foot traffic, birds, and cultivation spread seed. Moreover, roughstalk bluegrass can also propagate via stolon, and thus there are currently fewer control options. Poa weed infestations can become so severe in turfgrass that complete renovation is necessary, which is done by spraying the entire area with a nonselective herbicide followed by replanting with a desirable turfgrass species. It would be advantageous to provide for selective weed control to protect the health and appearance of the turfgrass before such drastic treatments are required.

At least one embodiment provides a method of controlling Poa in established dormant warm-season turfgrass (e.g., Bermuda, Zoysia, St. Augustine, or Centipede grasses) by applying a spray mix comprising clomazone at a rate of about 0.562 lb. clomazone/acre to about 1.125 lb. clomazone/acre (inclusive), starting when the warm-season turfgrass is at least 50% dormant to fully dormant (100% dormant), inclusive, but prior to at least 60 days before the spring transition (green-up) of the dormant turfgrass is expected. In some regions of the U.S., for example, clomazone may be applied in late fall but prior to mid-January. Those of ordinary skill in the art are well-able to determine when a turfgrass has reached about 50% dormancy or is fully dormant. Similarly, those of ordinary skill in the art can reasonably predict the expected (e.g., historical) timing of spring transition for a particular area and turfgrass and thus determine when the 60-day-limit before spring green-up will occur. This method can be applied to dormant turfgrasses on, for example, golf courses, residential and commercial properties, athletic fields, or sod farms. Applications according to this embodiment have resulted in control of existing and later germinating Poa and other weeds. In this embodiment, restricting applications to at least 60 days before the spring transition is expected alleviates the risk of delayed spring green-up or bleaching of the warm-season turf as it transitions out of dormancy. In any event, clomazone should not be applied to these turf types if spring transition is underway and delayed green-up or temporary bleaching can not be tolerated.

At least one embodiment provides a method of selectively controlling Poa and other winter-germinating weeds in an established warm-season or cool-season turfgrasses (e.g., Bermuda, Zoysia, St. Augustine, Centipede, Ryegrass, Fescue, or Kentucky Bluegrass turfgrasses), such as turfgrass in residential or commercial lawns, golf courses or athletic fields, while maintaining turf aesthetics by overseeding with cool-season grass (e.g., Ryegrass or Kentucky Bluegrass). This method comprises applying a spray mix of clomazone at a rate of about 0.562 lb. clomazone/acre to about 1.125 lb. clomazone/acre, then activating the clomazone by moisture activation (via irrigation or rainfall) within about 24 hours of clomazone application, then overseeding the clomazone-treated warm-season turfgrass with cool-season turfgrass seed about 3 days to about 7 days after application of the clomazone. The clomazone application timing and moisture activation of the clomazone results in control of existing and later germinating Poa with little to no bleaching of the germinating and emerging overseeded turf types. Although the application of clomazone according to this embodiment may bleach the established turf for about a month, the emerging cool-season overseed minimizes negative aesthetics. An advantage of this method is that it can be practiced before the warm-season grass is dormant. It should be noted that clomazone has not been previously labelled nor known as efficacious at controlling Poa, especially during germination and emergence of the cool-season turfgrasses, without unacceptable damage to the emerging cool-season turfgrass. Currently, no Poa-controlling herbicide is available or labelled for use during the germination and emergence periods of the cool-season turfgrass due to significant seedling plant stand reductions (death) of the emerging Rye or Kentucky Bluegrass turf types. Accordingly, this embodiment provides an important and surprising advantage over other Poa-controlling herbicides.

At least one embodiment provides a method of controlling Poa and other weeds during the establishment of a warm-season or cool-season sod production field (e.g., comprised of Bermuda, Zoysia, Ryegrass, Kentucky Bluegrass, or a mixture of these) by applying a spray mix comprising clomazone at a rate of about 0.562 lb. clomazone/acre to about 1.125 lb. clomazone/acre, from about 1 week before planting up to the same day as planting the grass seed into the soil at a depth of around 0.25 inch (¼ inch). Moisture activation via rainfall or irrigation is applied within about 24 hours of the clomazone application to avoid bleaching of the emerging crop and/or negatively affecting germination of the newly seeded improved turf types. Surprisingly, the timing of clomazone application, moisture activation, and seed planting according to this method avoids bleaching of the emerging turfgrass and/or negatively affecting germination of the newly seeded improved turf types. Clomazone applied in this method controls both existing Poa and future germinating/emerging Poa and other weeds without adversely affecting the germination and emergence of the recently seeded cool-season turfgrasses (Ryegrass or Kentucky Bluegrass, or a mixture of these). It should be noted that clomazone has not been previously labelled for, nor known as, efficacious at controlling Poa during germination and emergence of the cool-season turfgrasses without unacceptable damage to the emerging cool-season turfgrass. Avoiding infestation by Poa is especially advantageous for sod production fields, and the respective sod companies' reputations for not selling Poa-contaminated products.

At least one embodiment provides a method of controlling Poa and other weeds during the establishment of a cool-season, certified seed production field (e.g., seed of either Ryegrass, Fescue, or Kentucky Bluegrass) by applying a spray mix comprising clomazone at a rate of about 0.562 lb. clomazone/acre to about 1.125 lb. clomazone/acre, from about 1 week before planting up to the same day as planting the grass seed into the soil at a depth of about 0.25 inch to about 0.5 inch. Moisture activation (via rain or irrigation) of the clomazone normally occurs after planting. In many geographies irrigation is not feasible or available so the clomazone activating rain is also the moisture that simultaneously initiates seed germination. The planting depth (i.e., planting at a deeper depth such as about ½ inch) provides a buffer before the seedling imbibes the herbicide, thereby providing plant safety and anti-bleaching characteristics. Surprisingly, the timing of the clomazone application, turf type tolerance, moisture activation, and seed planting according to this method avoids bleaching of the emerging turfgrass or negatively affecting germination of the newly seeded improved turf types. Clomazone applied in this method controls existing Poa annua and Poa trivialis (collectively Poa), future germinating/emerging Poa annua and Poa trivialis, and other weeds without adversely affecting the germination and emergence of the recently seeded cool-season turfgrasses (Ryegrass and Kentucky Bluegrass). It should be noted that clomazone has not been previously labelled for, nor known as, efficacious at controlling Poa during germination and emergence of the cool-season turfgrasses without unacceptable damage to the emerging cool-season turfgrass. Avoiding infestation by Poa is especially advantageous for seed production fields, and the respective seed companies' reputations for not selling a Poa-contaminated product.

Further regarding certified seed production, it is a common cultural practice in some United States geographies to utilize herbicide-deactivating activated charcoal (aka activated carbon) over the planted seed to protect the planted seed from negative herbicidal effects during germination and establishment. See, e.g., Hulting & Spring, Grass Seed Crops, in PACIFIC NORTHWEST WEED MANAGEMENT HANDBOOK (Pacific Northwest Extension, Oregon State Univ., 2022). In these activated charcoal scenarios, clomazone may be used with all turf types previously mentioned (Ryegrass, Kentucky Bluegrass) as well as Fescue turf types. It also would be a benefit in these geographies to have the option to drop the expensive and labor-intensive effort required to apply the activated charcoal band when using Clomazone in Rye and Kentucky Bluegrass seed production fields. Clomazone has never been labeled for use in certified seed production, and the present embodiments offer an important new approach in quality control for these turf grasses.

In at least one embodiment, a method of selectively controlling Poa in improved turfgrass comprises use of a formulation comprising 3 lb. clomazone/gallon to prepare a spray mix (tank mix), or 5% clomazone granular formulation, for application at a rate of about 0.562 lb. active ingredient clomazone/acre to about 1.125 lb. active ingredient clomazone/acre, inclusive of these rates and rates therebetween. Example clomazone spray rates include 24 oz. per acre (0.562 lb. a.i./A), 32 oz. per acre (0.750 lb. a.i./acre), and 48 oz. per acre (1.125 lb. a.i./acre). In some embodiments, clomazone is applied in more than one application, for example an initial application at 32 oz. per acre, followed by a subsequent application at 16 oz. per acre, for example in application to dormant turfgrass. Granular clomazone application rates include 11.25 lbs. per acre (0.562 lb. a.i./A), 15 lbs. per acre (0.750 lb. a.i./acre), and 22.5 lbs. per acre (1.125 lbs. a.i./acre). In some embodiments, the clomazone is a microencapsulated liquid formulation. For example, methods for production of microencapsulated clomazone formulations are described in U.S. Pat. No. 9,764,302. In some embodiments, the application of clomazone according to this method controls at least 80% of Poa for at least 60 days (compared with Poa control in untreated turf).

The following examples are for illustrative purposes only. The examples are not intended as necessarily representative of the overall testing performed and are not intended to limit the invention in any way. As one skilled in the art is aware, in herbicidal testing, a significant number of factors that are not readily controllable can affect the results of individual tests and render them non-reproducible. For example, the results may vary depending on environmental factors, such as amount of sunlight and water, soil type, soil compaction, pH of the soil, temperature, and humidity, among other factors. Additionally, the depth of planting, the application rate of individual and combined herbicides, the application rate of any antidote, and the ratio of the individual herbicides to one another or to an antidote as well as the nature of turfgrasses or weeds being tested can affect the results of the test. Results may vary from turf to turf within the turfgrass varieties.

Other embodiments and uses will be apparent to one skilled in the art in light of the present disclosures. The following examples are provided merely as illustrative of various embodiments and shall not be construed to limit the invention in any way.

### EXAMPLES

### Example 1. Control of Poa annua

A trial was conducted in Tennessee in the fall of 2022 to demonstrate control of Poa annua (Poa). In this turf trial, clomazone was applied in early November with a use rate of about 0.75 lbs active ingredient (a.i.) per acre. FIG. 1, a photograph taken 6 weeks after clomazone application, shows Poa plants surrounding the clomazone-treated plot while no Poa plants exist inside the clomazone-treated plot.

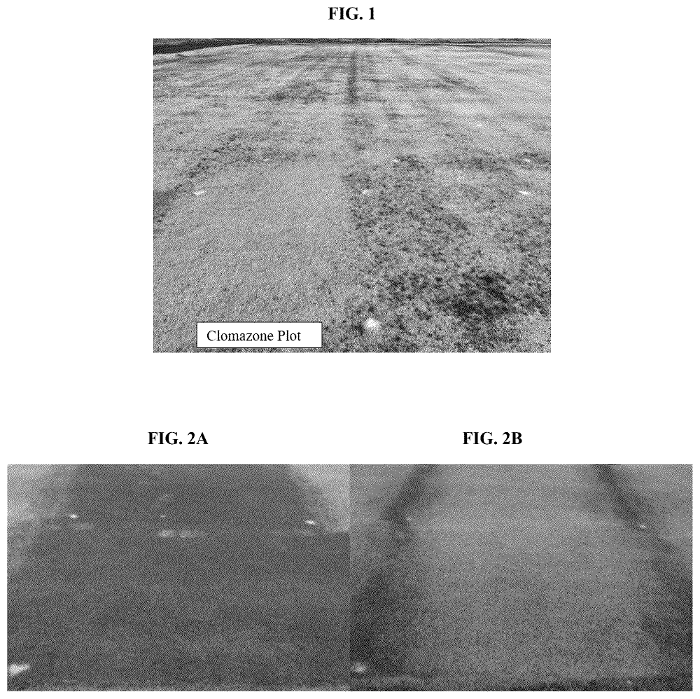

In the same fall 2022 trial, an earlier clomazone application timing of late September resulted in aesthetically unacceptable turf bleaching of warm-season turf, as illustrated in FIG. 2A and FIG. 2B. More specifically, FIG. 2A is a photo of the untreated control plot 34 days after treatment, and FIG. 2B is a photo of the clomazone-treated plot 34 days after clomazone was applied at a rate of 0.75 lb/acre.

This trial indicated that warm-season turf should be at least approaching dormancy, if not fully dormant, at the time of clomazone application to maintain acceptable turf aesthetics, unless it is being overseeded with cool-season turf types as described elsewhere herein.

### Example 2. Control of Poa in Dormant Bermudagrass

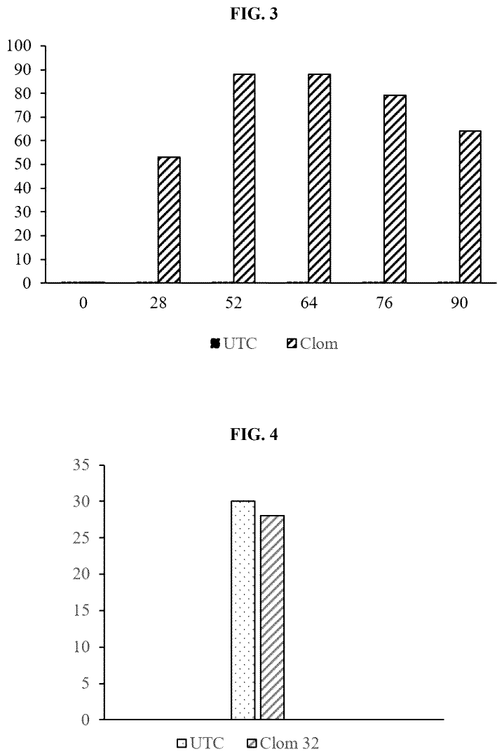

A trial was conducted in Tennessee on dormant Bermuda grass, initiated in early December 2023, which demonstrated that clomazone can be applied to control existing Poa in dormant turfgrass (e.g., in December) and provide additional months of pre-emergent control of Poa and other winter weeds. In this trial, clomazone was applied at a rate of about 0.75 lb/32 oz. when the temperature at application was about 45° F. The control of Poa in this trial is shown in FIG. 3, in which the untreated Poa serves as 0% control. As shown in FIG. 3, Poa was significantly controlled (at or near 80%) for more than two months after clomazone application.

This trial also compared the spring green-up (emergence from dormancy) between the untreated and clomazone-treated Bermudagrass. FIG. 4 reflects the data of the spring green-up of this Bermuda grass in March 2024 following the December 2023 application of clomazone to the dormant Bermuda grass according to this trial. As shown in FIG. 4, the percent green-up of the clomazone-treated grass 107 days after clomazone application (107 DAT) was nearly identical to that of the untreated turf.

This trial supports the conclusion that the application of clomazone to dormant improved turfgrass, such as Bermuda, when the turfgrass is at least 50% dormant to fully dormant (generally from late November through December), can provide control of pre- and post-emergent Poa for about 60 days to 75 days, and the clomazone application results in no delay in the spring green-up of the turfgrass.

### Example 3. Clomazone Application in Dormant Turfs

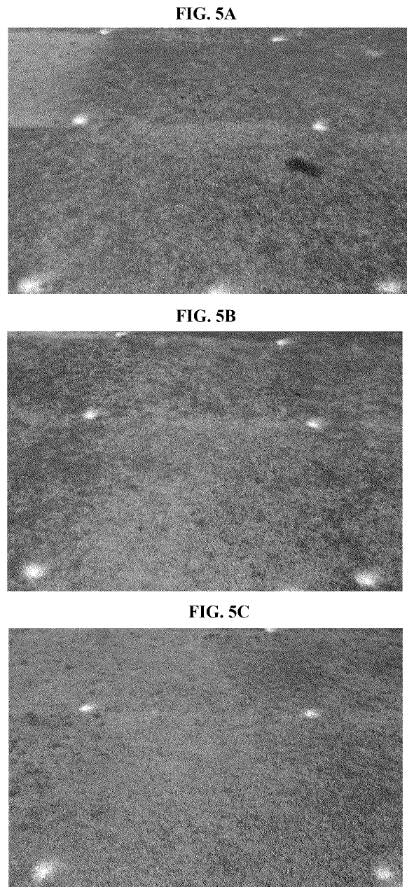

A trial was conducted to compare the risks of delayed spring green-up or bleaching of warm-season turf both in dormancy and as the turf transitions out of dormancy. Clomazone was applied to dormant Bermuda grass on December 5th (temperature at application about 35° F.) (FIG. 5A), January 26th (temperature at application about 51° F.) (FIG. 5B), and February 19th (FIG. 5C). The trial's Bermudagrass turf started breaking dormancy by early to mid-March. The photos shown in FIG. 5A-FIG. 5C were taken on March 21 and illustrate the risks the later applications (after mid-January) have for delayed green-up and bleaching of the Bermuda turf transitioning from dormancy.

As shown in FIG. 5A, clomazone application to fully dormant Bermuda grass and at least 60 days ahead of spring transition resulted in little to no delay in spring transition (green-up) and no turf bleaching, and weeds including Poa annua were selectively controlled. As shown in FIG. 5B, clomazone application to dormant Bermuda grass less than 60 days prior to spring transition resulted in a delay in spring green-up of the treated turf. As shown in FIG. 5C, clomazone application to dormant Bermuda less than 30 days prior to spring transition led to both a significant delay in green-up and light bleaching of the treated turf.

This trial showed that spring transition delay and turf bleaching may be avoided by applying clomazone to turf such as Bermuda when turf is dormant and at least 60 days prior to spring transition. This trial supports a method of controlling Poa in established dormant warm-season turfgrass (e.g., Bermuda, Zoysia, St. Augustine, or Centipede grasses) by applying a spray mix comprising clomazone at a rate of about 0.562 lb. clomazone/acre to about 1.125 lb. clomazone/acre (inclusive), starting when the warm-season turfgrass is at least 50% dormant to fully dormant (inclusive), but prior to at least 60 days before the expected spring transition of the turfgrass.

### Example 4. Circumventing Bleaching Effects of Clomazone

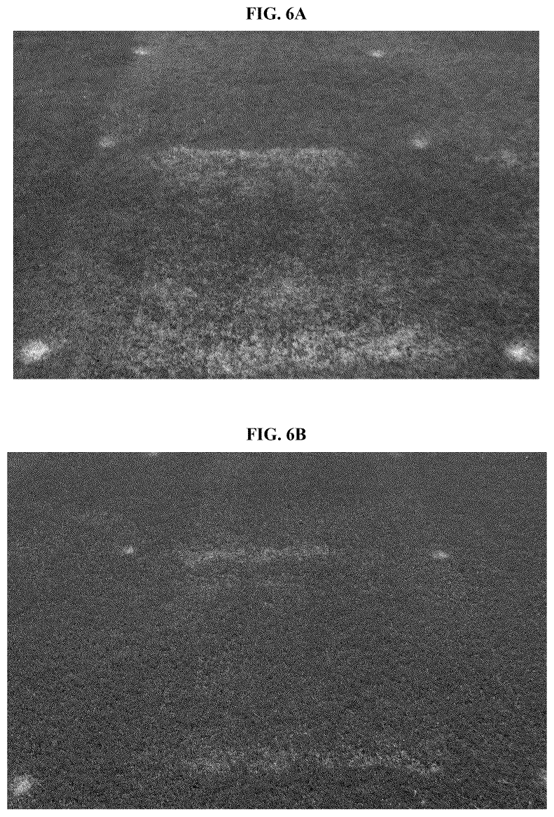

A trial was conducted to circumvent the known bleaching effects of clomazone by overseeding clomazone-treated turf. More specifically, in a trial conducted in Tennessee, clomazone was applied to non-dormant Bermuda turf (September 25th, when the temperature at application was 82° F.) at a rate of about 0.75 lb a.i./acre followed by moisture activation within 24 hr of the clomazone application, 7 days prior to seeding/overseeding with Ryegrass. FIG. 6A shows green Ryegrass emerging through bleached Bermudagrass at 22 days after treatment (22 DAT) with clomazone. FIG. 6B shows green Ryegrass emerging unbleached through bleached Bermudagrass turf at 30 days after clomazone treatment.

This trial demonstrated that although the application of clomazone according to this method resulted in bleaching of non-dormant Bermudagrass, there was little or no bleaching of the germinating and emerging Ryegrass, which began masking the bleached Bermudagrass in 10 to 14 days of overseeding, with complete transition to green Ryegrass in 3 to 4 weeks from overseeding. Concurrent with the growth of the Ryegrass, the bleaching of the Bermudagrass also declined to less than 9% by 30 days after the application. Importantly, pre- and post-emergent control of Poa at overseeding was achieved and continued for several months.

This trial supports the conclusion that clomazone can be used for the selective control of Poa and other weeds in an established Bermuda, St. Augustine, Centipede, Zoysia, Fescue turf types, Kentucky Bluegrass, or Ryegrass turfgrass (or mixtures of these improved turfgrasses), such as turfgrass in golf courses, athletic fields, or residential and commercial properties, by applying a spray mix comprising clomazone at a rate of about 0.562 lb. clomazone/acre to about 1.125 lb. clomazone/acre, inclusive, followed by moisture activation via irrigation or rainfall within about 24 hours of application, about 3 days to about 7 days prior to fall overseeding of the established turfgrass with Ryegrass or Kentucky Bluegrass seed. The clomazone application timing and moisture activation of the clomazone results in control of existing and later germinating Poa with little to no bleaching of the germinating and emerging Ryegrass or Kentucky Bluegrass. Although application of clomazone according to this embodiment may bleach the established Bermuda, St. Augustine, Centipede, Zoysia, Fescue turf types, Kentucky Bluegrass, or Ryegrass turfgrasses for about a month, the emerging overseed minimizes negative aesthetics. Because there have been no selective post-emergent herbicide control options available in this scenario, in which most Poa annua populations in overseeded situations are primarily established (or emerge) with the emerging Ryegrass or Kentucky Bluegrass, this method provides a significant unmet need.

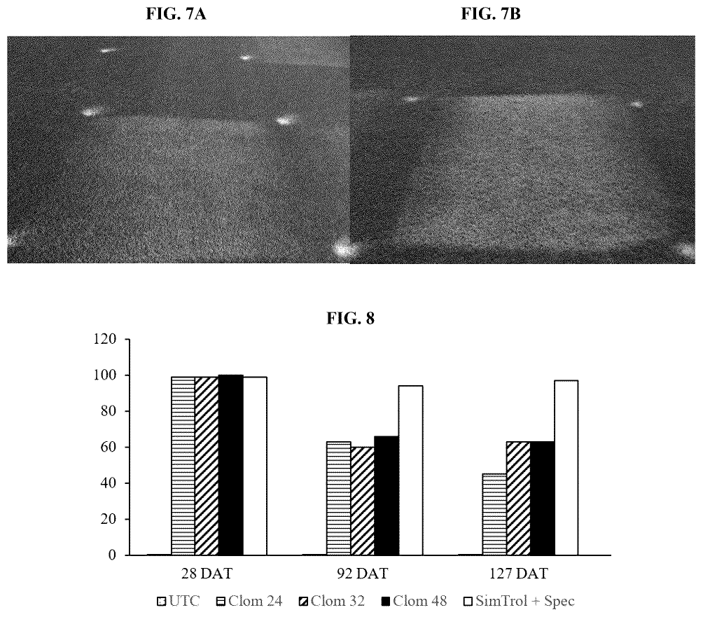

Later timings of clomazone application—after emergence of the germinated overseed (e.g., Ryegrass or Kentucky Blue Grass)—may result in unacceptable bleaching of the recently seeded grass. More specifically, in a post-emergence trial, clomazone was applied at a rate of about 0.75 lb per acre to emerged Ryegrass. FIG. 7 shows extensive bleaching of the clomazone-treated Ryegrass at 29 days (FIG. 7A) and 53 days (FIG. 7B) after treatment, respectively.

By comparing the results shown in FIG. 6 and FIG. 7, it is evident that clomazone application (and activation) about 3 days to about 7 days (about 1 week) before overseeding may avoid significant bleaching of the overseeded grass, whereas clomazone application after emergence of the overseed may result in unaesthetic bleaching.

Accordingly, although clomazone may cause bleaching of warm-season turf, this bleaching effect may be mitigated by application of clomazone (followed by moisture application) about a week before overseeding with a cool-season grass such that the cool-season grass emerges unbleached and healthy to provide an aesthetically pleasing turf. It should be noted that this method is also effective in controlling weeds in the turf grasses, including Poa.

### Example 5. Clomazone POA Control Trials in Warm-Season Turfgrasses

Applications were made to dormant Bermuda or Zoysia in several geographies testing Poa control using different amounts of clomazone and commercial comparators at different time points with respect to turfgrass dormancy and expected green-up.

In a trial in Alabama, clomazone was prepared as a tank mix comprising 3 lbs. a.i./gal and applied November 18 to Bermuda grass at rates of 24 oz/acre (fluid ounce/acre), 32 oz/acre, or 48 oz/acre. The comparator of the November application was a combination Sim-Trol® (simazine) 4 lb. a.i./gal applied at 32 oz/acre and Specticle (indaziflam) applied at 6 oz/acre. The temperature recorded at the time of application was 72° F. The results showing the percent Poa control in untreated control turf (UTC—0% control) and the herbicide-treated plots at 28, 92, and 127 days after application (DAT) are shown in FIG. 8A.

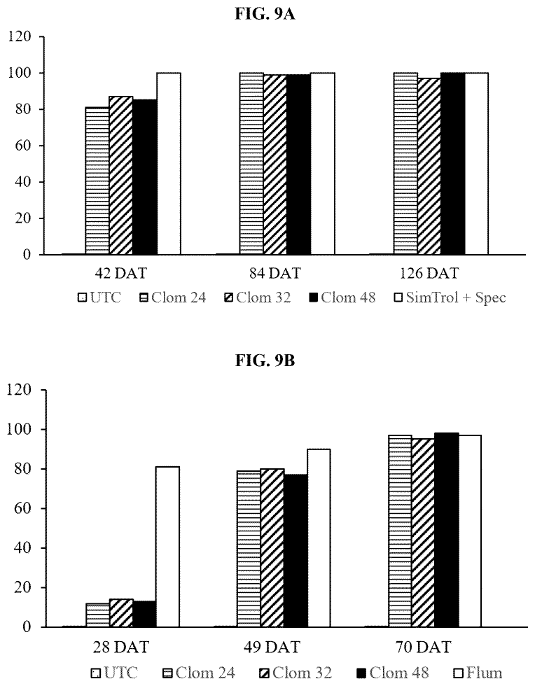

A similar trial was conducted in Viginia on Zoysia. Clomazone and the Sim-Trol/Specticle comparator were prepared as above. The temperature at the time of the November 21 application was 38° F., and moisture activation occurred within 24 hours of application. The results showing the percent Poa control in untreated and treated Zoysia plots at 42 DAT, 84 DAT, and 126 DAT are shown in FIG. 9A. Another Virginia dormant Zoysia trial was conducted in January, in which clomazone concentrations and flumioxazin were prepared as above and applied January 16. The temperature at the time of application was 45° F., and moisture activation occurred within 24 hours of application. Results comparing the percent Poa control in untreated and treated plots at 28 DAT, 49 DAT, and 70 DAT are shown in FIG. 9B.

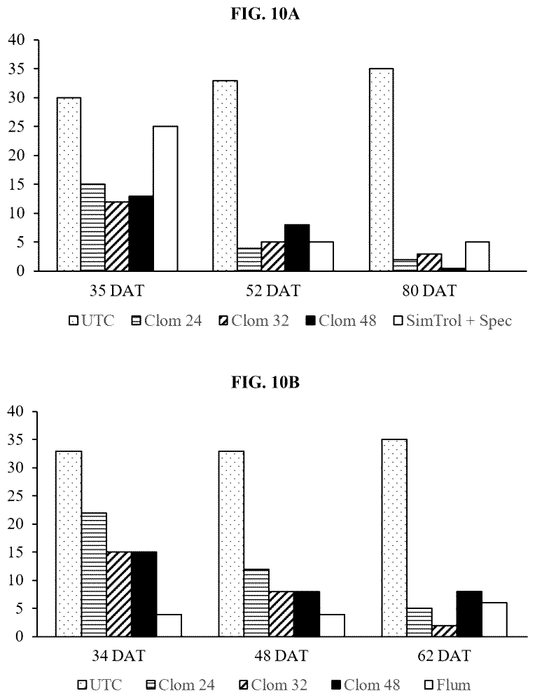

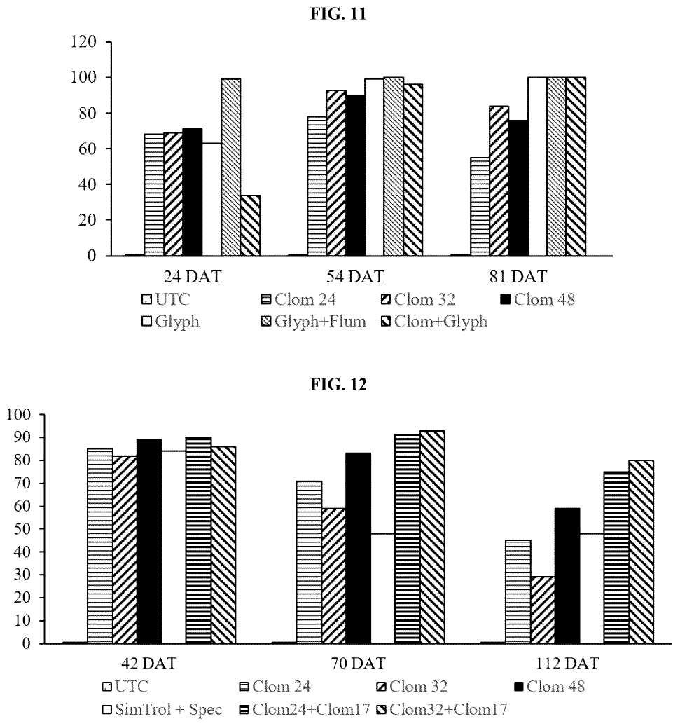

A further Poa control trial in dormant Bermuda was conducted in South Carolina. Clomazone and the Sim-Trol/Specticle comparator were prepared as above, and applied on December 20. Moisture activation occurred within 24 hours. The results of the trial, measured as the percent Poa coverage in control and treated plots, at 35 DAT, 52 DAT, and 80 DAT, are shown in FIG. 10A. Another South Carolina dormant Bermuda trial was conducted in January, in which clomazone concentrations and flumioxazin were prepared as above and applied January 17. Results of the trial, shown as percent Poa coverage of untreated and treated test plots at 34 DAT, 48 DAT, and 62 DAT are shown in FIG. 10B.

A trial was conducted in Tennessee to compare clomazone (three concentrations) versus glyphosate, a mixture of glyphosate and flumioxazin, and a mixture of clomazone and glyphosate, for control of Poa in dormant Bermuda turf Clomazone 24 oz/acre, 32 oz/acre, and 48 oz/acre were prepared as described above. Glyphosate was applied at a rate of 32 oz/acre; the mixture of glyphosate and flumioxazin was applied at 32 oz/acre glyphosate and 12 oz/acre flumioxazin; the mixture of clomazone and glyphosate was applied at a rate of 32 oz/acre clomazone and 32 oz/acre glyphosate. Application occurred on January 17, at a temperature of 43° F. Results tabulated as percent Poa control at 24 DAT, 54 DAT, and 81 DAT are shown in FIG. 11.

A further trial in Tennessee compared clomazone (three concentrations as above) and a mixture of Sim-Trol/Specticle (as above), with sequential applications of clomazone at two concentrations. More specifically, initial treatments were applied December 17, at a temperature of 49° F. (application A). Then, on some plots that had received either 24 oz/acre or 32 oz/acre clomazone, a second clomazone treatment at 17 oz/acre was applied on January 28, at a temperature of 45° F. (application C). The results for control and treatments at 42 DAT-A, 70 DAT-A, 112 DAT-A, 28 DAT-C and 70 DAT-C are shown in FIG. 12.

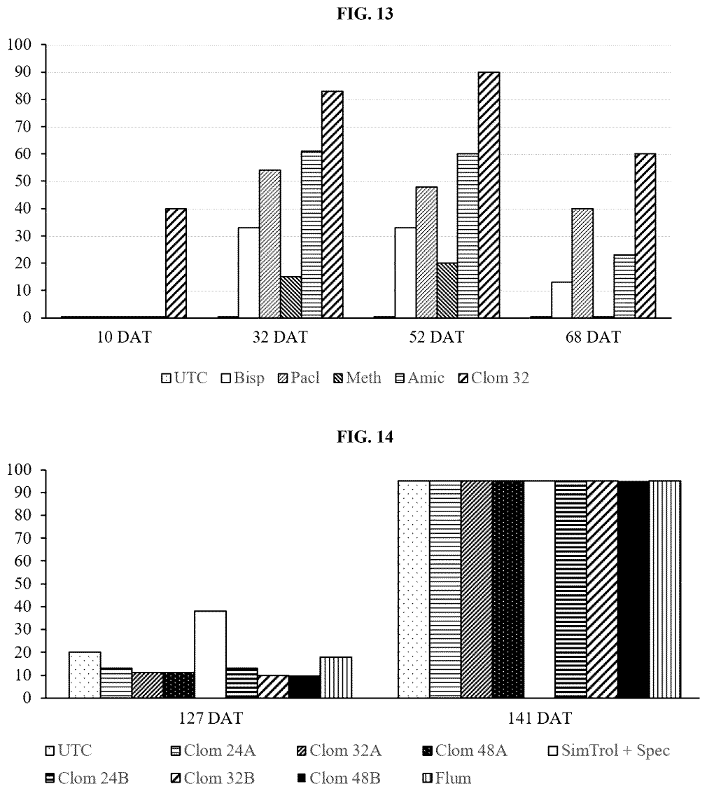

Another trial in Tennessee compared clomazone with other herbicides for the control of 2-3 year old, mature Poa trivialis. More specifically, clomazone was applied at 32 oz/acre, bispyribac sodium was applied at 2.25 oz/acre, paclobutrazol PGR was applied at 48 oz/acre, methiolzolin was applied at 51 oz/acre, and amicarbazone was applied at 4 oz/acre. Treatments were applied on March 7. The percent P. trivialis control was assessed at 10 DAT, 32 DAT and 52 DAT, and 68 DAT. The results are shown in FIG. 13 and indicate that the clomazone treatment successfully controlled P. trivialis.

These trials support the use of clomazone in controlling Poa in warm-season turfgrasses such as Bermuda, Zoysia, St. Augustine, and Centipede turfgrasses. In particular, the application of clomazone at 32 fl oz/acre (0.734 fl oz/1000 square feet), with moisture activation within 24 hours of clomazone activation, provides effective of post-emergent control of existing Poa annua. Additionally, clomazone provides 60-75 days of pre-emergent control of Poa.

### Example 6. Green-Up of Dormant Warm-Season Turfgrasses Following Clomazone Application

As a complement to the control of Poa in dormant warm-season turfgrasses, the effects of clomazone and other herbicide treatments (as described in Example 5) on green-up (the spring transition out of dormancy) were compared. Delayed green-up may affect turf vigor, and other detrimental issues may include turf bleaching, turf phytotoxicity (beyond acceptable delay or aesthetic bleaching), and turf stand loss (winter kill).

In the trials in Alabama described above, in addition to providing data on Poa control, November and January applications of clomazone and Sim-Trol/Specticle (November, providing DAT-A), an additional trial with clomazone treatments versus flumioxazin was applied in January (January 17, DAT-B), and all turfs were assessed on March 15 (127 DAT-A) and again on April 8 (141 DAT-A) to assess Bermuda grass turf recovery following clomazone treatments. The results, as the percent turf spring green-up, are shown in FIG. 14.

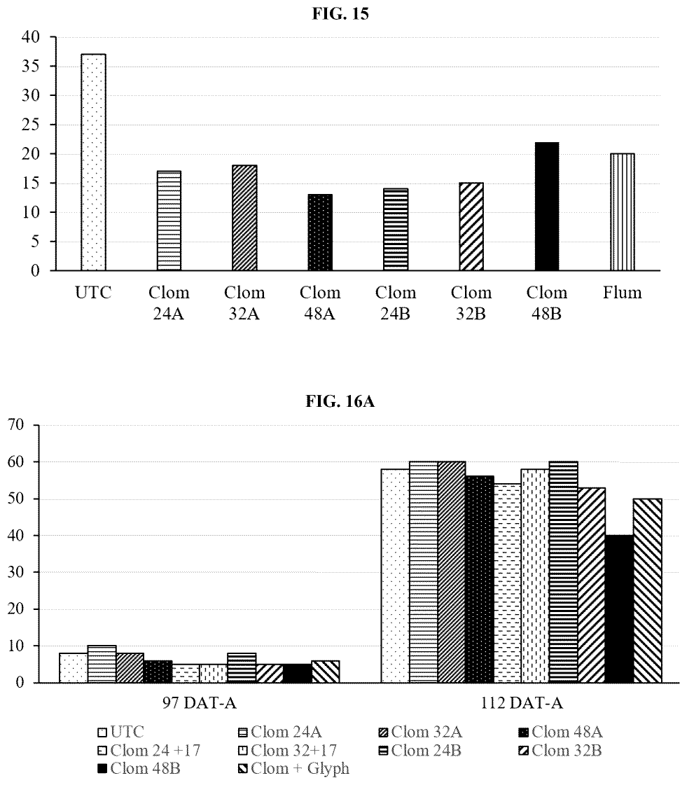

For the trials in South Carolina described above for clomazone and comparator applications in December 20 (date A) and January 7 (date B), Bermudagrass green-up was assessed April 14 (115 DAT-A), and the results are shown in FIG. 15.

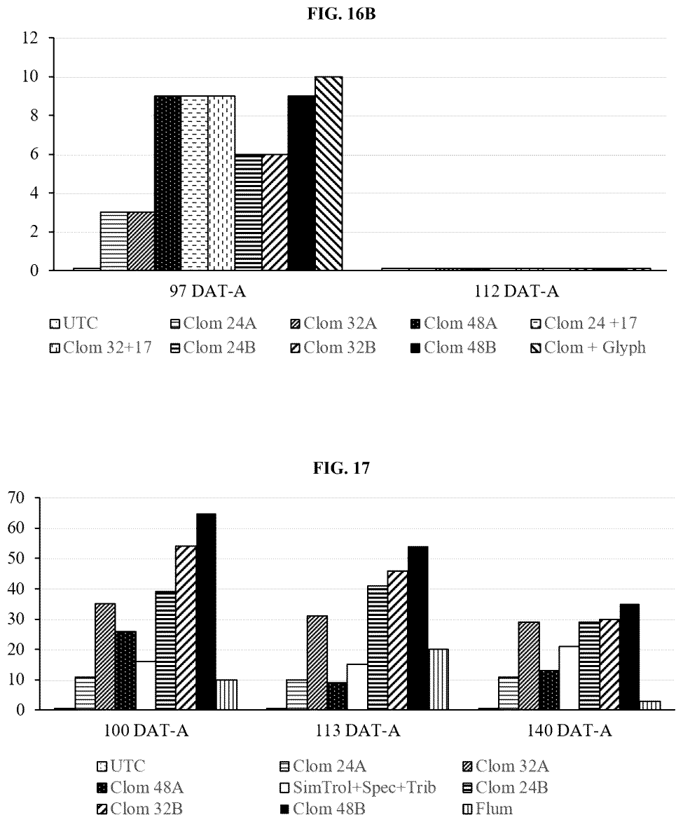

For the trials in Tennessee, Bermuda grass green-up was assessed for the three concentrations of clomazone applied December 17 (A), the sequential applications of clomazone on December 17 and then January 28, and the January 17 application of clomazone and the clomazone/glyphosate mixture (B). Green-up was assessed on March 24 (97 DAT-A) and April 8 (112 DAT-A), and the results are shown in FIG. 16A. As part of the Tennessee green-up assessment, the percent of the turf showing phytotoxicity/bleaching was assessed on March 24 (97 DAT-A) and April 8 (112 DAT-A), as shown in FIG. 16B.

Green-up was also assessed in Mississippi following application on December 12 of each of the three clomazone concentrations or a mixture of 32 oz/acre Sim-Trol, 6 oz/acre Specticle and 1 oz/acre Tribute® Total (thiencarbazone-methyl, foramsulfuron, halosulfuron-methyl) (application A), and application on January 3 of each of the three clomazone concentrations or flumioxazin as above (application B) to dormant Bermuda grass. In this study, the Bermuda turf was drought-stressed as it transitioned to dormancy, which can exacerbate winter damage and negatively affect herbicide tolerance and speed of spring green-up transition. Spring transition turf health was assessed March 21 (100 DAT-A, 78 DAT-B), April 3 (113 DAT-A, 91 DAT-B), and April 30 (140 DAT-A, 118 DAT-B) as a percent of turf injury, and results are shown in FIG. 17.

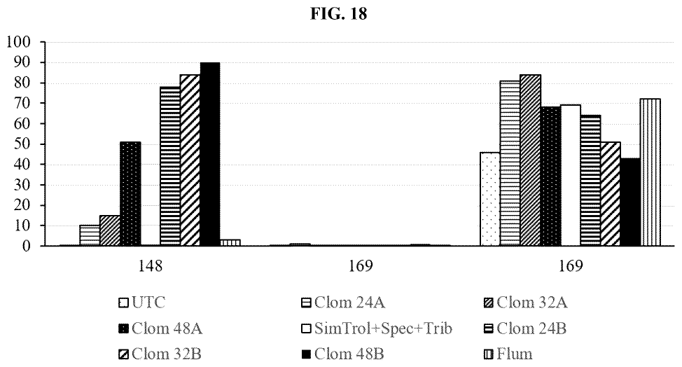

As part of the Virginia trial on dormant Zoysia described above, spring green-up was measured as a percent of turf phytotoxicity/bleaching on April 18 (148 DAT-A) and May 9 (169 DAT-A) and also assessed as a percent of turf coverage on May 9 (169 DAT-A). The results are shown in FIG. 18.

The results of these experiments show that clomazone was successful in consistently controlling Poa annua in dormant warm-season turfs during the November and December application window, and application of clomazone can be managed to support spring green-up of the treated turfgrasses. For example, clomazone full rate applications after January 1 tended to result in more delayed green-up or bleaching during spring transition. Clomazone at 32 oz/acre rate was selected as a standard rate that provided adequate Poa control and acceptable turf green-up. Additionally, November-December clomazone application followed by a half rate of 16 oz in January (30-45 days later) significantly extended Poa control without causing unacceptable spring transition issues.

### Example 7. Clomazone Applications in Overseeding

As discussed above, overseeding is used in various settings to provide adequate turf. For example, the practice of overseeding Bermuda turf with perennial Ryegrass in the fall is used to enhance aesthetics, playing surfaces and protect the dormant Bermuda turf (e.g., from foot and equipment traffic stresses) during winter dormancy. A currant practice is to apply Revolver® (foramsulfuron), 7 days prior to applying Rye seed, to kill the existing Poa without affecting Ryegrass germination. Because Revolver has no residual control/soil activity, Poa germinates with the Ryegrass seed and currently there are insufficient control measures to selectively kill emerged Poa in Ryegrass or prevent Poa germination during the overseed process. There remains a need for Poa control in overseeding practices. Several experiments were undertaken to assess the use of clomazone in overseeding projects.

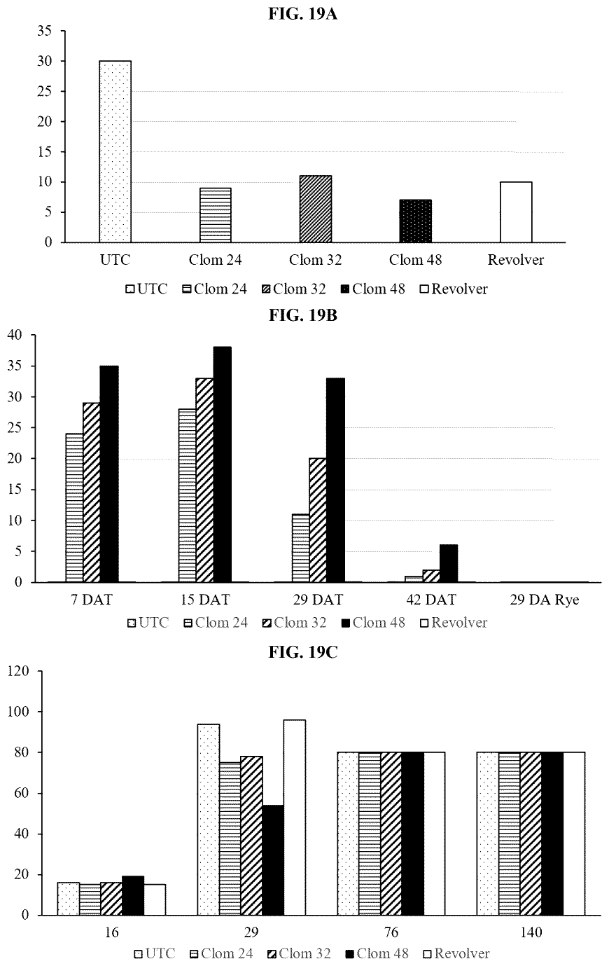

A study in Alabama compared clomazone treatments with Revolver application. Clomazone was applied at either 24 oz/acre, 32 oz/acre, or 48 oz/acre, and Revolver was applied at 17.4 oz/acre. All treatments were applied on September 24, 7 days prior to perennial Ryegrass overseeding, then the percent plot coverage by P. annua was measured March 25 (182 DAT). The results are shown in FIG. 19A. Importantly, no phytotoxicity, bleaching, or stand reduction was observed in the Rye. The Alabama trial also assessed the percent turf injury/bleaching in the Bermuda grass upon which the Rye was overseeded. The Bermuda grass was assessed at 8 DAT, 15 DAT, 29 DAT, and the observation of the Rye at 29 days after overseeding (DA) was also assessed. The results are shown in FIG. 19B. Further, the Alabama trial assessed the percent turf coverage provided by the Ryegrass at 16, 29, 76, and 140 days after overseeding (DA). The results are shown in FIG. 19C.

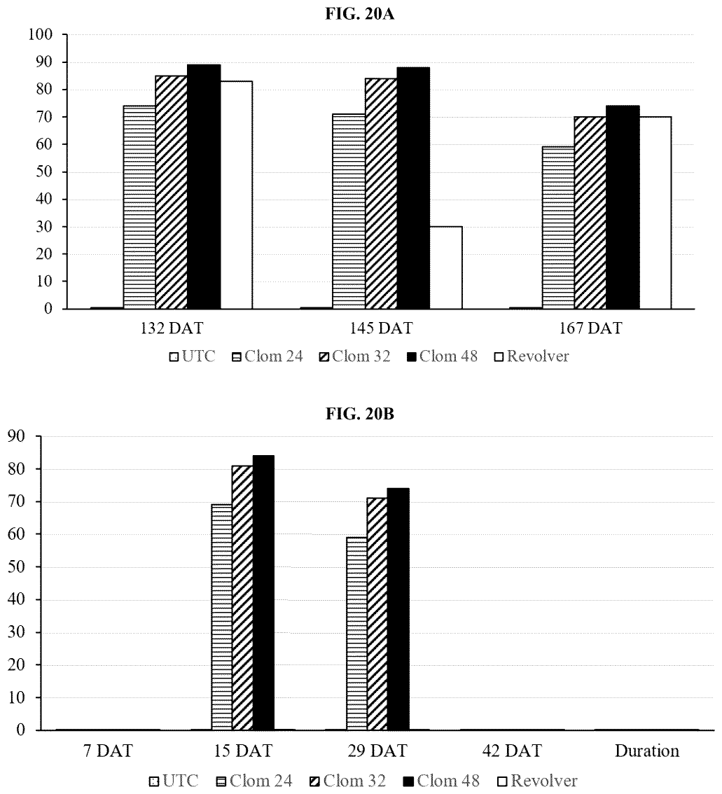

A similar trial was conducted in North Carolina, comparing clomazone treatments with Revolver application. The treatments were applied October 16, 7 days prior to perennial Rye overseeding. The results were tabulated as the percent Poa control at 132 DAT, 145 DAT, and 167 DAT, and are shown in FIG. 20A. As part of this trial, the percent turf injury/bleaching of the Bermudagrass (treated with clomazone and overseeded with Rye) was assessed at 7, 15, 29, 42 DAT, then at the end of the observation period (Duration). The results are shown in FIG. 20B. Importantly, no phytotoxicity, bleaching, or stand reduction was observed in the Ryegrass.

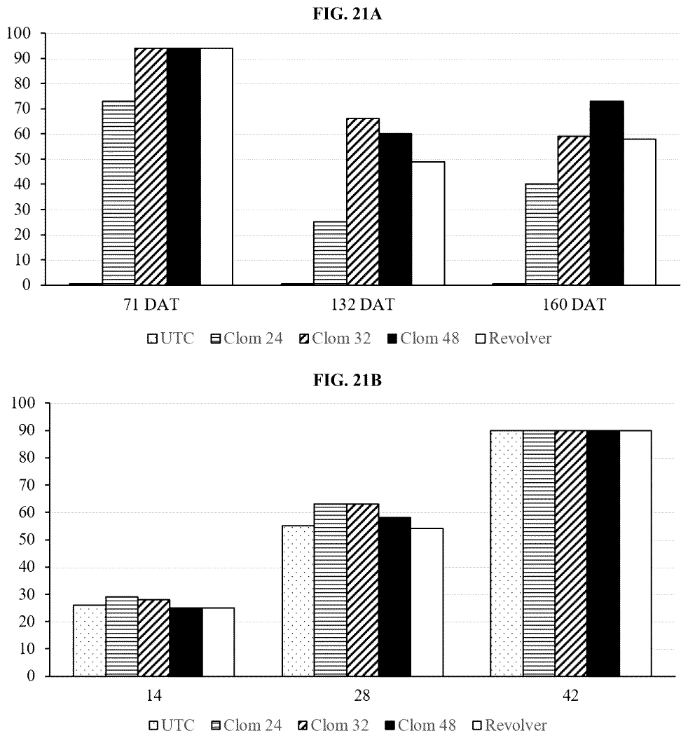

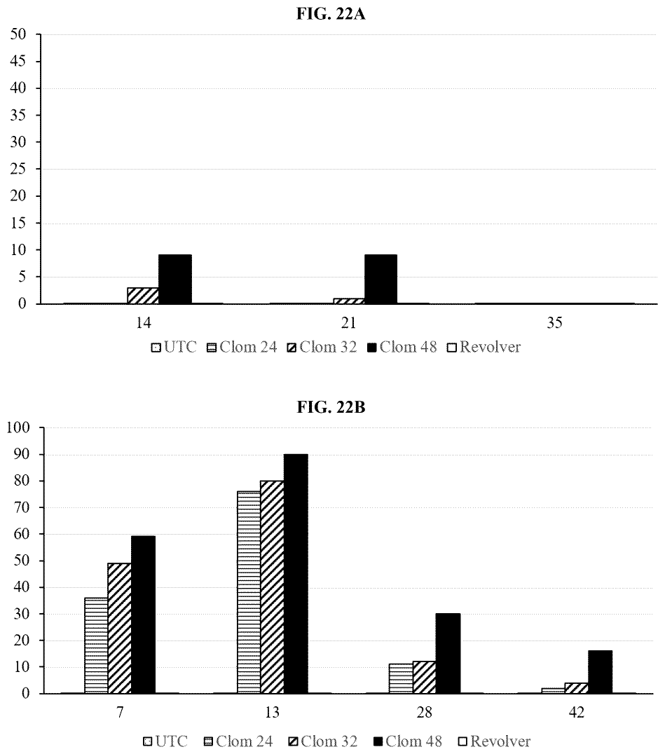

A similar study was also conducted in Tennessee comparing the three clomazone concentrations with Revolver. All treatments were applied September 23, 7 days before perennial Rye overseeding. The treatments were assessed for percent P. annua control at 71 DAT, 132 DAT, and 160 DAT, and the results are shown in FIG. 21A. The Tennessee overseeding trial also assessed the amount (percent) of Ryegrass coverage at 14, 28, and 42 days after overseeding, and the results are shown in FIG. 21B.

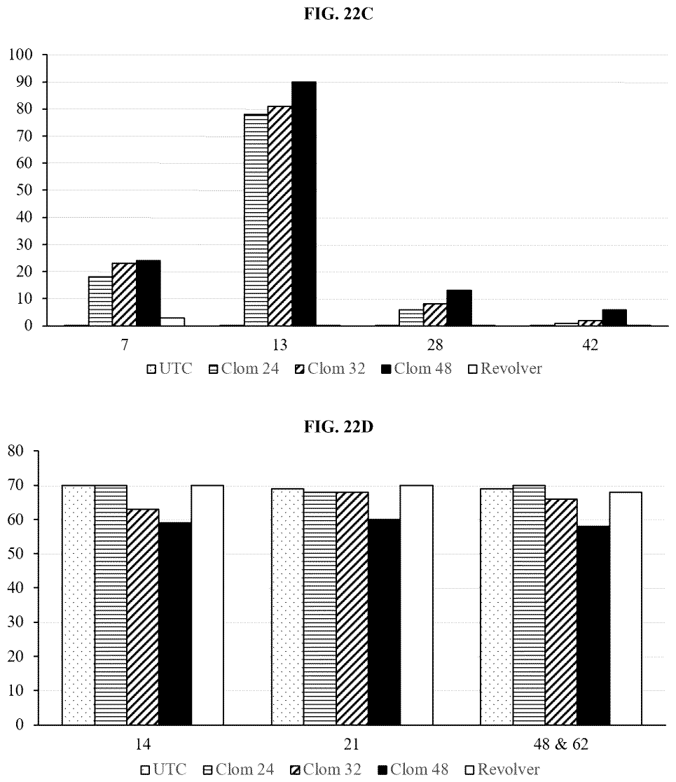

A similar study was conducted in Virginia, comparing the three clomazone concentrations with Revolver. Treatments were applied September 13, 7 days prior to overseeding with perennial Rye. The amount (percent) of bleaching of the Ryegrass was assessed at 14 DAT, 21 DAT, and 35 DAT. The results are shown in FIG. 22A. The Virginia overseeding trial also assessed percent Bermuda turf bleaching and injury, which was assessed at 7 DAT, 13 DAT, 28 DAT, and 42 DAT. The results are shown in FIG. 22B (% Bermuda bleaching) and FIG. 22C (% Bermuda injury). The Virginia trial further assessed the percent Rye coverage at 14 DAT, 21 DAT, and 48 and 62 DAT. The results are shown in FIG. 22D.

In other trials, it was observed that concurrent (same-day) clomazone treatment and Ryegrass overseeding held back the establishment of the Ryegrass, and that the Ryegrass vigor and proliferation was less than in tests in which clomazone treatment preceded Ryegrass overseeding. Clomazone application (and activation) about 3 days to 7 days before overseeding may avoid significant damage to the overseeded grass and provide selective weed control and acceptable turf aesthetics.

The clomazone overseed trials as provided herein were successful in controlling Poa annua and allowing perennial Ryegrass to emerge unbleached, without delay or reduced stand populations. Indeed, clomazone controlled P. annua equal to or better than the standard Revolver, both applied at 7 days prior to overseeding. Depending on the Ryegrass height of cut maintained, another residual Poa herbicide may be required around 60 days to 75 days later to extend Poa control to Ryegrass termination in the spring. For example, sports fields tend to have a much higher cut and may not require an additional application as the higher cut assists in weed control.

It is to be understood that the disclosure has been described in conjunction with the above embodiments, and that the preceding description and examples are intended to illustrate and not limit the scope of the disclosure. Other aspects, advantages, and modifications within the scope of the disclosure will be apparent to those skilled in the art to which the disclosure pertains.

I claim:

1. A method of selectively controlling weeds in improved turfgrass comprising applying clomazone to the improved turfgrass at a rate of about 0.562 lb. clomazone/acre to about 1.125 lb. clomazone/acre, inclusive of these rates and rates therebetween.

2. The method of claim 1, further comprising preparing a clomazone-containing spray mix or tank mix from a formulation comprising 3 lb. clomazone/gallon.

3. The method of claim 1, wherein the application is a clomazone spray applied at a rate of 24 oz. per acre (0.562 lb. a.i./A), 32 oz. per acre (0.750 lb. a.i./acre), or 48 oz. per acre (1.125 lb. a.i./acre), or the application is a clomazone granular applied at a rate of 11.25 lb. per acre (0.562 lb. a.i./A), 15 lb. per acre (0.750 lb. a.i./acre), and 22.5 lb. per acre (1.125 lb a.i./acre).

4. The method of claim 1, wherein the clomazone is a microencapsulated liquid formulation or an impregnated granule.

5. The method of claim 1, wherein the improved turfgrass is Bermuda grass, Zoysia grass, St. Augustine grass, Centipede grass, Ryegrass, Fescue turf-type grass, Kentucky Bluegrass, or mixtures of these improved turfgrasses.

6. The method of claim 1, wherein the weed is Poa annua L. or Poa trivialis (collectively “Poa”).

7. The method of claim 6, wherein clomazone-treated Poa is controlled at about 80% or more for at least 60 days compared with untreated Poa.

8. A method of controlling pre- and post-emergent weeds in established warm-season turf comprising:
(a) determining that the warm-season turf is about 50% dormant to 100% dormant,
(b) predicting that the warm-season turf is at least 60 days from expected spring transition,
(c) applying to said warm-season 50% dormant to 100% dormant turf a spray mix comprising clomazone at a rate of about 0.562 lb. clomazone/acre to about 1.125 lb. clomazone/acre, inclusive of these rates and rates therebetween.

9. The method of claim 8, wherein the weed is Poa annua L.

10. The method of claim 8, wherein the warm-season turf comprises at least one of Bermuda grass, Zoysia grass, St. Augustine grass, or Centipede grass.

11. The method of claim 8, wherein the warm-season turf is present in a golf course, an athletic field, a residential or commercial property, or a sod farm.

12. The method of claim 8, wherein the spray mix comprises at least one additional herbicide in addition to clomazone.

13. The method of claim 8, wherein the spray mix comprises at least one agronomically acceptable excipient.

14. A method of selectively controlling weeds in an established warm-season or established cool-season turf comprising:
(a) applying to said warm-season or cool-season turf a spray mix comprising clomazone at a rate of about 0.562 lb. clomazone/acre to about 1.125 lb. clomazone/acre, inclusive of these rates and rates therebetween,
(b) activating the applied clomazone with water within about 24 hours of clomazone application, and
(c) overseeding said warm-season or cool-season turf with cool-season turfgrass seed about 3 days to about 7 days after the application of the clomazone.

15. The method of claim 14, wherein the warm-season or cool-season turf comprises at least one of Bermuda grass, St. Augustine grass, Centipede grass, Zoysia grass, Ryegrass, Fescue turf types, Kentucky Blue Grass, or a mixture of these.

16. The method of claim 14, wherein the overseeding with cool-season turfgrass seed is Ryegrass or Kentucky Blue Grass seed.

17. The method of claim 14, wherein the weed is Poa annua L or Poa trivialis.

18. The method of claim 14, wherein the spray mix comprises at least one agronomically acceptable excipient.

19. A method for selectively controlling weeds during the establishment of a warm-season or cool-season turf sod production field or a certified seed production field, comprising:
(a) applying to the warm-season or cool-season turf sod production field or seed production field, a spray mix comprising clomazone at a rate of about 0.562 lb. clomazone/acre to about 1.125 lb. clomazone/acre, inclusive of these rates and rates therebetween, wherein the clomazone is applied at a time from about 1 week before planting to the same day as planting a grass seed selected for establishment in the production field into the soil at a depth of about 0.25 inch to about 0.5 inch; and
(b) moisture-activating the applied clomazone after clomazone application.

20. The method of claim 19, wherein the weed is Poa annua L. or Poa trivialis.

21. The method of claim 19, wherein the warm-season or cool-season turf comprises at least one of Bermuda, Zoysia, Ryegrass, Fescue, Kentucky, or Bluegrass.

22. The method of claim 19, wherein the spray mix comprises at least one agronomically acceptable excipient.

23. The method of claim 19, further comprising the steps of providing activated charcoal (activated carbon) over said certified seed in a production field, wherein said certified seed production is Fescue seed.
